(19) United States
(12) Patent Application Publication
(10) Pub. No.: US 2013/0068410 A1
(43) Pub. Date: Mar. 21, 2013

(54) Production of Flake Particles

(71) Applicants: David Edward Higgins, Commondale (GB); Peter Gerald Lederer, Malvern (GB); Andrew Martin Pitt, Malvern (GB); Siân Donohue, Malvern (GB)

(72) Inventors: Paul Peter Donohue, Malvern (GB); David Edward Higgins, Commondale (GB); Peter Gerald Lederer, Malvern (GB); Andrew Martin Pitt, Malvern (GB)

(73) Assignee: QINETIQ LIMITED, Farnborough Hampshire (GB)

(21) Appl. No.: 13/391,335

(22) PCT Filed: Aug. 20, 2010
(86) PCT No.: PCT/GB10/01576

§ 371 Date: Sep. 5, 2012

(30) Foreign Application Priority Data
Aug. 21, 2009 (GB) 0914632.5
Jan. 5, 2010 (GB) 1000055.2

(51) Int. Cl. B22F 9/02; B32B 15/04

(52) U.S. Cl. CPC B22F 9/02; B32B 15/04
USPC 164/72; 106/400; 428/173

(57) ABSTRACT

The invention enables thin film particles of a controlled shape and size to be generated directly upon release of a thin film coating from a textured Substrate upon which they are grown directly. The substrate comprises an array of discrete, steep sided plateaus of a selected size and shape, from which discrete particles of a corresponding shape and size are releasable usually by means of an intermediate release layer coating on the plateaus. The process is readily scalable for high volume production and permits monomodal or multimodal particle size distributions. Such particles may be used as specialised pigments in the security, anti-counterfeiting, defence and cosmetics industries.

### FIELD OF THE INVENTION

The present invention relates to a method of generating flake particles and to release systems and coated intermediates used in such methods, as well as collections of such flake particles. The invention particularly relates to the production of flake particles of a controlled shape and size for use, for example, in the paints, inks, cosmetics and anti-counterfeiting industries, where such particles may require specific optical, electrical, magnetic or rheological properties.

### BACKGROUND OF THE INVENTION

A variety of prior art methods exist for the manufacture of inorganic flakes ranging from casting methods using water or jets to break up a molten metal stream, atomising methods that atomize and spray molten metal, to mechanical methods such as grinding up of released deposited films. For example, in recent years disc shaped, inorganic, micron scale, flake pigments for commercial ink and paint systems have been made by depositing (e.g. sputtering) a thin inorganic film upon a flexible web substrate that has been treated with a release agent, stripping the inorganic film from the substrate, filtering the released flake so generated and reducing the flake size to the required micron scale, usually by grinding and agitation.

Applicant's earlier International patent application WO 02/072683 describes a release film system for manufacturing inorganic flake particles which uses an intermediate layer mineral release layer such as vermiculite to assist with release of a deposited film of inorganic flake material from a web substrate. The film can be released in the form of random flakes which are collected and processed to the desired size for use in ink pigments or paint coatings applications. U.S. Pat. No. 5,135,812 is similarly directed to the production of optically variable flakes for use in paints and inks, and teaches the sizing of flakes by methods such as ultrasonic agitation or, for very fine particles, also by using air grinding.

WO 2006/116641 describes a process for making embossed fine particulate thin metallic flakes where the release surface is embossed with a fine diffraction grating pattern, and then metallised with a metal film which on release by stripping yields flakes on which the diffraction grating pattern with a groove depth of 125-140 nm is replicated. The resulting flakes have an average particle size of about 75 microns after metal stripping which size is maintained by omitting any high energy mixing or particle sizing steps.

All of the above prior art methods, however, rely upon break up of a deposited film to form flakes of an uncontrolled size and shape, with downstream processing steps used to achieve finer size control.

EP1741757 describes how opaque flakes with a selected shape are made by coating a flake material on a substrate, embossing frames onto the material or the underlying substrate as lines of weakness, such that when the film is removed the flakes tend to break along the frame lines so that they are substantially uniform in size. It is suggested that only a small portion (e.g. 10%) of the substrate should be so embossed such that a percentage of covert sized flakes are generated. This method still relies on fracture of a film to generate particles and references a loss of yield when processing the embossed portion of the substrate.

### SUMMARY OF THE INVENTION

The present invention provides a method of directly depositing discrete flake particles of a controlled size and shape comprising providing a textured substrate comprising an array of discrete, steep-sided exposed plateaus of a selected size and shape, and depositing a film forming material over the entire array such that it forms discrete, releasable flake particles of a corresponding size and shape on the plateaus.

The present method allows flake of a controlled size and geometry to be generated directly in large amounts on the plateaus. Preferably, the method includes subsequently releasing and collecting the flakes, whereby the flakes still have the same corresponding size and shape and have not been broken up. The method is readily scalable so as to permit high volume production, for example, by reel to reel processing. The flake may be formed from any suitable film-forming material and may, for example, be inorganic, organic and/or metallic in nature and may be single layered or multi-layered.

For the flakes to be releasable, the textured substrate should have inherent releasing ability with respect to the type of flake material being deposited, such that the latter is releasable therefrom.

By “corresponding size and shape” we mean the same or a related, closely similar size and shape.

While deposition is conducted over the entire array (i.e. non-directionally and without the use of templates), the textured substrate is inherently designed so as to cause discrete flake particle generation. In addition to the controlled geometry, there is the advantage that flakes formed directly as discrete flakes tend to be surprisingly flat. By contrast, flakes formed from continuous films by releasing and sizing operations tend to exhibit curling due to tension effects unless the film deposition is very carefully controlled.

In a further aspect, there is provided a method of producing shaped flake particles comprising the steps of: —

a) providing a release system comprising a textured substrate comprising a plurality of discrete, steep-sided plateaus of a selected size and shape, and coated with a film of release agent;
b) producing a coated intermediate by depositing a film of material on the substrate such that it forms discrete flake particles on the plateaus;
c) releasing the discrete flake particles from the coated intermediate.

Rather than coating the entire substrate as a continuous film, as in the prior art, the release agent film will usually be discontinuous over the substrate, i.e. not continuous, being broken up at the plateau edges and corners.

The term “plateau” is used herein to refer to a substantially level stretch of substrate of the same height and suitable for forming a deposition area for a flake particle; the area may be a raised/higher area or a sunken/lower area (i.e. valley) with respect to the substrate immediately surrounding it. The plateaus are delimited by steep sides around substantially their entire perimeters such that they are discrete elements i.e. substantially unconnected, and hence, individually distinct. While the plateaus are substantially level that does not exclude the use of raised or lowered motifs or indicia (e.g. diffraction gratings) on the plateaus, which may be desirable for example on flakes used for covert security applications. The array will usually be a regular, ordered pattern and will be designed to maximise yield of flake particles usually through the use of close-packed and/or tessellating plateaus.

Use of the present release system thus enables the textured substrate directly to define the desired shape, size and even percentage yield of subsequently deposited and released flake particles, without the need for any downstream sizing/filtering processes. Thus, the substrate can be engineered to generate a desired final size distribution in the flake particles upon their initial release. Moreover, because the flake particles can be formed on the discrete plateaus as individual flakes the flakes do not need to have any fracture edges, which can be an important advantage for certain reactive inorganic or metallic materials (e.g. aluminium), as well as improving the reliability of the final shape.

The use of the textured substrate also enables the production route to be simple; for example, both the release agent and material can be deposited indiscriminately (non-directionally) over the entire active area of the substrate since the steep plateau walls cause their subsequent segregation and confinement on the plateaus.

The surface of the textured substrate is conveniently formed from an embossed photopolymer.

In a preferred arrangement, the steep sided plateaus are each coated with a discrete cap of release agent film on top of which cap is deposited a discrete flake of material of a related size and shape (e.g. varying within about 10%). Edge beading of the release agent around its periphery due to surface tension effects is desirable, since the overhang appears to encourage isolation of the subsequently deposited material film as a discrete flake. Other overhanging structures could also be used to encourage discrete flake generation, with or without release agent. For example, an embossed structure could be passed through a hot nip to cause a slight flattening of the tops of raised plateaus, or if a textured structure is produced by a non-embossed method, such as an etching method, then chemical etching could be used to produce rounded overhanging capped plateaus.

The plateaus are usually delimited by steep side walls having a depth of at least 2 microns. A textured surface with steep walls of at least this depth (as opposed, for example, to the fine detail of a diffraction grating with a typical groove depth of ˜0.1 micron) ensures the coating of the release agent is confined to discrete, designated flat areas (the plateaus), the discontinuous nature of the release film giving rise to correspondingly discrete patches of flake material. More preferably, the plateau depth will be at least 4, ideally at least 5 microns. Preferably, the plateaus will have minimum side dimensions of at least 2 microns, ideally at least 4 or 5 microns to assist flake releasability. Minimum side dimensions of at least 10 microns, however, are usually preferred.

In certain specific applications where very thin inorganic films of less than 1 micron are being deposited (e.g. optical films of 50-100 nm i.e. up to 0.1 micron), and a thin release agent film is also used, the plateau depth may be at least 1 micron.

For embossed structures, the side length of any plateaus should preferably be of the same order or greater than the depth/height of the trenches/cliffs between the plateaus; preferably the ratio of the trench/cliff depth to minimum plateau side length is usually at least 1:1, preferably at least 1:1.5 or 1:2. Thus, if an embossed substrate is used, any sunken areas (indentations) in the embossed structures should preferably not be deeper than they are wide, and should be straight sided or flare outwardly towards their opening to permit removal of the embossing shim.

The relief angle should be such that uniform (i.e. non-directional) application of the release agent does not lead to permanent coating of the steep-sided walls with dried release agent or flake material, which might lead to a continuous film of flake material and prevent the subsequent release of discrete flake particles. A relief angle of between 0° and ±40° to the substrate normal (vertical), preferably up to ±25°, will be used depending on the technique for fabricating the texturing. While other texturing techniques may employ negative angles (concave trenches), embossed structures can only use+angles (to allow shim removal) and will preferably be in the range 0-25°, more preferably, 5-20°.

Flake generating plateaus may form at least 25% of the active area. The present method enables high shape yield efficiency of target particle shapes and is readily scalable for high volume production using continuous substrates with widths for example of the order of 0.3 m-2 m widths.

By “active area”, it is intended hereinafter to refer to that part of the substrate where it is intended to carry out deposition and subsequent flake generation. For example, in a continuous substrate used for reel to reel processing there may be front and end sections, intermediate “rest” sections, as well as side sections, that may not be used specifically for shaped flake generation. The active areas and inactive areas may be textured and untextured, respectively, but there may be circumstances where an area is still textured but is inactive, for example, due to apparatus incompatibility issues.

In the method conveniently at least half of the active area of the substrate comprises raised plateaus suitable for flake production, preferably with a minimum side dimension of at least 5 microns.

Preferably, the substrate is arranged such that flakes are only generated from raised plateaus, since these usually provide the most effective release surfaces; these raised plateaus may form a significant part of the active area, preferably at least 50% or 60%, or even 70% thereof, and may be the only intended shaped flake generation areas. The raised plateaus may be arranged in a close packed array and ideally should not be interconnected, although some bridges at vertices may be unavoidable.

Alternatively, the active area of the substrate may comprise raised and sunken plateaus in a close-packed array, each preferably having a minimum side dimension of at least 3 microns. In a preferred arrangement, about half the active area comprises raised plateaus and the other half comprises sunken plateaus, preferably abutting and alternating with one another so that there are no other “grid-lines” dissecting the substrate, and preferably with equal sized raised and sunken plateaus.

However, in some instances, the active area may be arranged with the surface area consisting of all raised (or all sunken) plateaus divided up by a much narrower, interconnecting network of flat, sunken (or raised) areas that may also generate useful fine particles. Such an interconnecting network may be required to surround complex and/or irregular plateau shapes (e.g. logo-shaped plateaus).

Advantageously, immediately after release the flake particles are of a corresponding size and shape in two dimensions to the selected size and shape of the plateaus and typically will be subsequently collected still in that form in a formulation. However, in a less preferred embodiment, flakes may be released and broken up into random or selected smaller sizes in one dimension, while retaining the width of the plateaus in the second dimension. For example, plateaus intended for flake generation may be in the form of elongate ribs i.e. having one side length that extends continuously across the length or width of the substrate (especially an elongate web substrate) or active area thereof. In that case, the ribs may be provided, at regular repeat intervals along their length, with protruding notches forming “waists”, or with dissecting bar lines of raised or lowered micron (e.g. 0.1-2 micron depth) relief, that represent lines of weakness that will facilitate the subsequent fracture of the elongated flake particles at the desired respective repeat intervals either upon stripping or during subsequent sizing operations. The present method has been shown to be capable of replicating such notches or relief features.

The active area may be textured with raised and/or sunken plateaus of the same geometry where a substantially mono-modal distribution is required. Where multi-modal distributions are required, the active area may be textured in the form of significant selected proportions of different geometric types of shaped flake generating plateaus, i.e. each type being of a different specific size and shape, so as to give rise to corresponding selected proportions of flakes of the different geometries.

In the release system the textured substrate may have one of the following configurations: —

i) the active area of the substrate is formed predominantly of raised plateaus segregated by an interconnecting grid network of lower trenches;

The present invention has the flexibility that it allows a huge variety of different shaped flakes to be generated and this particular arrangement with the interconnecting network can be used to surround any complex, irregular or non-tessellating plateau shapes. Preferably plateau dimensions are at least 5 microns, or even 7 microns and preferably at least 10 microns, to assist release.

To achieve high theoretical “shape yield” efficiencies, the plateaus should be close packed with narrow trenches, thereby maximising the yield of useful flake particles.

ii) the active area of the substrate is formed predominantly of an alternating chequerboard of raised plateaus and sunken plateaus.

This design provides release from the top and bottom of the substrate and hence has the potential to generate high yield efficiencies. It can even be used for small lateral particle dimensions of less than 10 or even 5 microns, although very small dimensions may mean release is only effective from raised plateaus leading to a yield efficiency of 50%. The plateaus comprise any suitable tessellating shapes (i.e. ones that fit together without leaving gaps), which may, for example, be regular or irregular, and may be straight-edged shapes such as squares, rectangles, hexagons, triangles, or diamonds, or curved tessellating shapes such as teardrops. The raised and sunken plateaus are usually all of the same size and shape, for example, where the walls are near vertical, but may be of a slightly differing size and shape, for example, with less steep walls, although the regularity of the chequerboard and preferably the segregation of the raised plateaus should be maintained.

Where textured substrates are produced using embossing shims, resulting in a loss of lateral definition, a “handedness” can be created for small dimensions leading to tiny interconnections or small gaps between neighbouring raised plateaus (which abut at their corners); the latter are preferred, since they still allow effective release of discrete particles from the raised plateaus.

iii) the substrate is formed predominantly of alternating raised plateaus and sunken plateaus in the form of continuous ribs and continuous trenches, respectively.

This design yields released discrete flakes of the selected rib width and may be preferred where high aspect particles are required. The design provides high yield efficiency in that release occurs equally from both ribs and trenches. The ribs may have pre-defined, selectively spaced, lines of weakness such as notches that encourage the flake particles to fracture into selected flake lengths after release, or the ribs may fracture randomly into flake of variable lengths, optionally with the subsequent use of ultrasonic agitation or similar methods to achieve the desired size. The ribs and trenches will usually be of equal size and shape and parallel; they may extend across the whole width (or length) of the substrate or over a large fraction thereof.

The substrate may include fine 3D relief features such as ID motifs or indicia provided upon the shape generating plateaus, for example, where covert flakes are required for security or anti-counterfeiting applications.

The choice of substrate will depend on which technique is selected to create the 3-D texturing. Ideally, a continuous web suitable for use in reel to reel processing may be used that can withstand the downstream deposition and release stages needed to generate the flake. Where an embossed substrate is used, a PET substrate is suitable as long as processing temperatures are not excessive. Other polymer substrates might include polyester, polypropylene, polyethylene, polyethylene naphthanate, polyether sulphone, polybutene, olefin copolymers, polyamide, polyimides, polycarbonate and polyacrylonitrile. The substrate may have an overlay of a relief forming polymer, preferably, an embossable photopolymer. WO 96/35971 describes a method of preparing such a micro relief element with the three-dimensional structures described therein having repetitive patterns protruding above the substrate. Other methods of creating textured substrates could use other web materials such as metal foil substrates, these being suitable for example for producing flakes of material which need to be deposited at high temperatures.

The release agent is preferably selected so as to cause release of the flake particles when the substrate is immersed in an aqueous medium, optionally with flexing and/or agitation. A release agent that disperses/dissolves in water and hence can be applied as a water-based solution and that is also stripped using water as the stripping solvent is highly preferred for environmental reasons. While release agents that can be applied as water-based solutions are preferred, additional steps or pretreatments may be needed to encourage them to “wet” the embossed substrate, which will usually be polymeric, properly due to surface tension effects. Release agents that can be applied and stripped using organic solvents may also be used, often without needing such wetting pretreatments. An example of one suitable such organic-solvent compatible release agent would be PMMA.

In a preferred embodiment, the release agent is a clay mineral. Phyllosilicates or sheet silicates form parallel sheets of silicate tetrahedra and an important group within the phyllosilicates is the clay mineral group. By the term “clay mineral” we intend to cover both natural and artificial clay minerals. The clay mineral group (also known as layer minerals) includes natural clay minerals such as kaolinite, illite, smectite, montmorillonite, hectorite, vermiculite, talc and pyrophyllite, and synthetic clay minerals, for example, synthetic smectites such as Laponite®. In this invention the use of (2:1) phyllosilicates with an octahedral sheet sandwiched between two tetrahedral sheets is preferred, especially the “swelling clays”. Such clay minerals contain large percentages of water trapped between the silicate sheets and can readily absorb or lose water leading to significant expansion or contraction as the water fills the spaces between the stacked silicate layers. Hence, once the textured substrate is exposed to water and this comes into contact with a release agent layer of clay mineral, rapid swelling and delaminating of the release agent layer permits ready release of the flake particles. The release (in normal water or preferably, deionised water) is rapid and efficient and indeed, so comprehensive that there is the possibility of re-using the textured substrate after minimal cleaning. Since the clay minerals can be applied as a water-based solution using roll-to-roll methods such as bead coating, the application of the release coating can form part of a reel-to-reel process.

Clay minerals are also fine grained (normally considered to be less than 2 microns in size), and the fine grains or platelets are desirable for maintaining the fidelity of embossed features and minimising disruption to the overcoated layer. Clay minerals with platelet sizes of less than 100 nm are especially preferred. Laponite® tends to form disc shaped crystals of ˜1 nm by 25 nm, and this is smaller than for example a bentonite platelet (˜300 nm).

Other water-soluble, film-forming materials known in the art that could be used include polymers such as, for example, vinyl acetate type resins, polyvinyl alcohol (PVA), polyethylene oxide, polyacrylamide, or polyvinylpyrrolidone. Another suitable “water soluble” type release agent is Borax (also known as sodium borate, sodium tetraborate, or disodium tetraborate). The film-forming material needs to exhibit suitable adherence to the selected embossed substrate, as well as suitable releasing ability, and also exhibit good coverage as a film without retraction.

The flake forming material may be any suitable film forming, preferably vacuum or vapour depositable, material; the material may be inorganic, organic or metallic and may especially be ones used in the production of thin film pigment flake. The invention is especially suitable for producing flat shaped flakes, particularly ones with specialised optical properties (e.g. highly coloured and/or reflective) and/or specialised magnetic properties and/or specialised electrical (or electro-optic) properties e.g. flakes for thermochromic coatings.

The material will usually be metallic or inorganic. It may be a metal or a metal containing material or an inorganic compound, the latter usually being a metal containing compound, and by way of example the material may be an alloy, an intermetallic, dielectric, semiconductor or a glass. An organic material such as PTFE could also be deposited (e.g. sputtered). The flake may be made from a single layer or from multilayers of any of the above materials, for example with outer upper and lower protective coating layers, for example, inorganic barrier layers such as SiO₂ or Si₃N₄, or organic layers such as PTFE.

Typical metals include aluminium, chromium, magnesium, copper, vanadium, nickel, zinc, tin, silver, gold, titanium, silicon, bismuth or indium. Bright metals such as, for example, silver, aluminium, copper, indium and nickel are typically used to produce pigment flakes with high levels of brightness and colour intensity for use in coatings and printing inks. The metallic material may also be an alloy (for example, of the afore-mentioned metals, e.g. an aluminium alloy, Ag—Au alloy, etc), which may be magnetic (hard or soft) or non-magnetic, an intermetallic or any other suitable metal-containing compound. Soft magnetic alloys may be used, for example, for generating anti-counterfeiting pigments and suitable commercially available alloys include CoFeSiMoB, CoZrNb and Permalloy (Fe_{0.2}Ni_{0.8}). Deposited materials may also be dielectrics or semi-conductors and typical examples of inorganic compounds may include oxides (e.g. VO₂), nitrides, fluorides and carbides.

On the coated intermediate, the discrete flakes comprise a single deposited layer or sequentially deposited multilayers of film forming materials, the multilayers being selected from the same or different materials. The use of selected upper and lower layers can provide some three-dimensional control with, for example, protective or passivating layers employed to form an outer coating.

The present invention is especially suitable for providing flake particles having a thickness of 0.01 microns-10 microns and a diameter (average side length) of 3 microns to 300 microns, up to a preferred maximum of 1 mm. For paint applications, flake particles will normally be of the order of 1 to 60 microns.

In a preferred method, step a) includes a step of manufacturing the initial textured substrate comprising a plurality of discrete, steep-sided plateaus of a selected size and shape. This may be by reel to reel processing and may involve embossing the substrate, for example, embossing a UV curable embossable photopolymer superstrate supported on a substrate. Step a) may also include a step of applying a release agent solution and drying the same to form the coated release agent layer.

The substrate of step a) may already have been subjected to a wetting treatment to improve its subsequent wetting by the release agent or step a) may actively include such a wetting treatment step; these steps are usually necessary where water-soluble release agents are to be used. Alternatively, or, additionally, step a) may include applying a release agent solution that includes a wetting agent in order to improve wetting of the substrate by the release agent. As a result the release agent film “wets” the substrate surface on the plateaus as a continuous film. This may be achieved by a corona discharge treatment (also known as plasma discharge) of the embossed substrate prior to the application of the release agent, and/or by use of a wetting agent such as a surfactant in the release agent coating solution. Other techniques for achieving wetting of the substrate by the release agent will be known to the skilled person. The wetting treatment should result in a complete, continuous cap of release agent on the plateaus preferably with edge beads forming around the perimeter of the caps of release agent film; these edge beads are believed to be important and form both on raised plateaus and sunken plateaus, while the vertical or near vertical side walls remain uncoated with release agent. The formation of the edge bead appears to create a shadowing effect which leads to the flake particles being generated as separate individual islands. This discontinuity may also facilitate release of shaped particles, particularly in the case of a water soluble/water-swellable release agent such as a clay mineral.

The deposition of the metallic or inorganic film can be carried out by methods that cover the entire active area of the substrate (rather than requiring localised deposition methods such as electrodeposition). Deposition does not need to be restricted to the plateau areas using, for example, shielding or templates because their relief causes discrete flake generation thereon. The film can be deposited by any suitable methods, and preferably those based on vacuum or vapour deposition, and these may include chemical vapour deposition (CVD) methods or physical vapour deposition methods (PVD) such as sputtering, thermal evaporation, ebeam evaporation, spraying or similar methods.

In thermal evaporation the coating metal is joule heated, under high vacuum, in a crucible to beyond its melting point after which it evaporates and will coat a substrate placed above the crucible. In sputtering a target material is, under partial vacuum, subjected to bombardment from heavy ions (usually Ar) in an ionised gas. The target is eroded and the liberated material then coats a substrate placed close to the target.

The material is deposited as a thin film of one or more material layers, which may have a total depth in the range of 0.05 to 10 microns, more usually less than 3 microns.

Step c) may comprise stripping the particles by flexing the substrate, preferably around one or more rollers, or planar-faced bars, and may also include agitation and/or filtration. Preferably, the substrate is immersed in tap water or deionised water, flexed, and exposed to an ultrasonic bath. Release of discrete flakes of the desired size is usually surprisingly good, such that downstream processing is unnecessary. If required, however, agitation may assist in breaking down any undesired bridges and/or reducing particle sizes, while simple filtration may remove undesired smaller or larger or irregular particles, for example, undesired sprues or large connected irregular particles.

For high volume production, the method may be conducted using an elongate flexible web substrate in a reel to reel process.

The process may be conducted batch-wise or continuously. The processing may incorporate re-use of the substrate after a cleaning step fully to remove any remaining release agent coating and/or deposited inorganic material.

In a further aspect, the present invention provides the use of a textured substrate or release system as specified above to generate flake particles of a controlled shape and size.

There is further provided, in another aspect, a novel coated intermediate comprising a textured three-dimensional substrate having an array of discrete, steep-sided plateaus of a selected size and shape and coated with a discontinuous film of release agent, on top of which is deposited a discontinuous film of material in the form of releasable flake particles. The steep sided plateaus are preferably each coated with a discrete cap of release agent film on top of which cap is deposited a discrete flake of material of a related size and shape.

Additionally, the present invention provides a novel release system for use in the above method comprising a textured substrate comprising a plurality of discrete, steep-sided plateaus of a selected size and shape, and coated with a discontinuous film of release agent that forms a discrete cap of release agent film on each plateau of a corresponding size and shape to that plateau.

In a further aspect, there is provided a novel collection of flake particles, preferably in a liquid formulation that is water or organic solvent based, said particles being obtainable or obtained according to the methods described above, wherein most of the particles fall into one category of a particular size and shape, or several such distinct categories, the particles in any one category being substantially identical under microscopic examination.

The flake particles may be single layered or multilayered, and any such layers may be of the same or different composition. The flake particles are characterised in that under microscopic examination it will immediately be evident that they clearly fall into identical size and shape categories e.g. clearly a unimodal/bimodal/trimodal etc distribution and are formed by the present templating method. The particles are also preferably characterised by edges that have not been fractured, for example, by grinding or agitation. The size/shape distribution will follow that of the respective relief features of the active deposition areas of the substrate.

Variation of side lengths within a category will be very small, with occasional bridging or interconnecting of plateaus across commonly shared side edges or vertices. Each category will be readily identifiable as such, since the technique is robust in replicating the respective plateau configurations and percentage distributions.

### BRIEF DESCRIPTION OF THE DRAWINGS

The present invention will now be described, by way of example only, with reference to the accompanying drawings, in which: —

FIG. 1 is a schematic flow diagram for a process for manufacturing thin film shaped flake particles according to the present invention;

FIG. 2 is a schematic cross-section through an embossed substrate overcoated with release agent and an inorganic (or metallic) thin film;

FIG. 3 is a flow diagram illustrating the main steps of a process for manufacturing shaped flake particles according to the invention;

FIG. 4 is a schematic flow diagram illustrating the steps conducted with respect to a substrate for a preferred process of manufacturing shaped flake particles;

FIGS. 5a, 5b and 5c are respective schematic diagrams of three alternative grid/rib/chequerboard textured substrate designs;

FIG. 6 is a schematic diagram showing three alternative sets of dimensions for the grid substrate design of FIG. 5a;

FIG. 7a is a schematic diagram of a specific grid (FIG. 5a) embossed substrate design with 5 μm×50 μm plateaus (5 μm wide×5 μm deep trenches), FIG. 7b is an SEM micrograph of the corresponding embossed photopolymer substrate, and FIG. 7c is an SEM micrograph of the same after coating with a release agent layer;

FIGS. 8a, 8b are SEM micrographs of a 50 μm×100 μm plateaus (5 μm wide×5 μm deep trenches) embossed photopolymer substrate of the FIG. 5a grid design, and FIGS. 8c, 8d are SEM micrographs of the same after coating with a release agent layer;

FIGS. 9a and 9b are optical micrographs of 5 μm×50 μm and 50 μm×100 μm shaped flakes released from the substrates of FIGS. 7 and 8, respectively;

FIG. 10a is a schematic diagram of a continuous rib, 5 μm width/repeat, embossed substrate design, and FIG. 10b is an optical micrograph of a corresponding substrate;

FIG. 11a is a schematic diagram of a continuous chequerboard, 10 μm×50 μm plateaus, embossed substrate design, and FIG. 11b is an optical micrograph of a corresponding substrate;

FIG. 12a is a schematic diagram of a continuous chequerboard, 5 μm×50 μm plateaus, embossed substrate design, and FIG. 12b contains two optical micrographs of the released shaped flakes;

FIG. 13 is two SEM micrographs of a Permalloy and release agent (with surfactant additive) coated 5 μm×50 μm chequerboard substrate;

FIG. 14 is two SEM micrographs of a Permalloy and release agent (without surfactant additive) coated corona treated 5 μm×50 μm chequerboard substrate;

FIGS. 15a and 15b are, respectively, optical micrographs of released Permalloy particles from a surfactant treated substrate and a corona treated substrate;

FIG. 16 is two SEM micrographs of a ˜3 μm×50 μm chequerboard embossed web;

FIG. 17 is two SEM micrographs of an Atalante® CoFeSiMoB film and release agent (with surfactant) coated substrate;

FIG. 18 is an optical micrograph of the released Atalante® CoFeSiMoB film particles;

FIG. 19 is two SEM micrographs of an Atalante® CoZrNb film and release agent (with surfactant) coated substrate;

FIG. 20 is two optical micrographs of the released Atalante® CoZrNb film particles;

FIGS. 21a and 21b are respectively, SEM micrographs of Borax coated embossed substrates with wetting treatments of (a) surfactant and (b) corona;

FIGS. 22a and 22b are, respectively, SEM micrographs of Polyacrylamide coated embossed substrates with wetting treatments of (a) surfactant and (b) corona;

FIG. 23 is an SEM micrograph of a PMMA (LG156) coated embossed substrate;

FIGS. 24a and 24b are, respectively SEM micrographs of Borax released shaped particles of (a) thermally evaporated Al and (b) ˜1 μm thick sputtered permalloy:

FIGS. 25a and 25b are, respectively, SEM micrographs of Polyacrylamide released shaped particles of (a) thermally evaporated Al and (b) ˜1 μm thick sputtered permalloy;

FIGS. 26a and 26b are, respectively, SEM micrographs of PMMA released shaped particles of (a) thermally evaporated Al and (b) 1 μm thick sputtered permalloy; and,

FIG. 27 is a schematic diagram of apparatus for stripping the inorganic shaped flake particles.

### DETAILED DESCRIPTION OF THE INVENTION

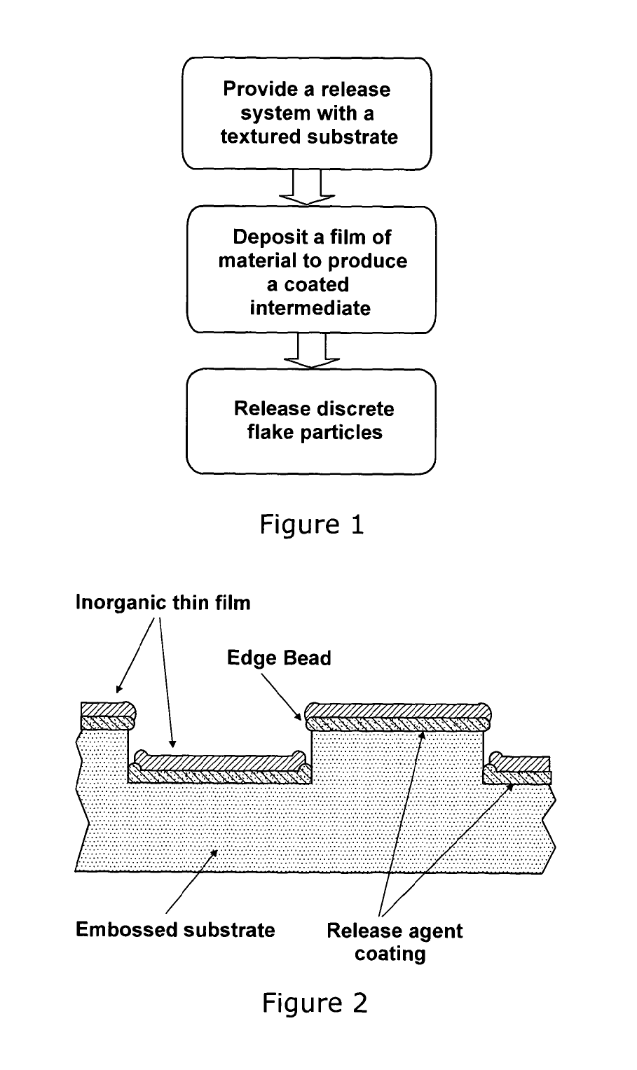

Referring to FIG. 1, this illustrates the main steps in a process for manufacturing shaped flakes according to the invention, namely: —
providing a release system with a textured substrate;
depositing a film of material to produce a coated intermediate;
releasing the discrete flake particles.

By way of example, FIG. 4 shows a schematic flow diagram illustrating the steps of a preferred process for manufacturing shaped flake particles such as, for example, micron scale, metallic or inorganic flake pigment that could be used in formulations in the cosmetics or security industries. The process allows flake of controlled size and geometry to be produced directly and rapidly, and is readily scalable for high volume production.

The process requires a textured three-dimensional substrate with steep-sided plateaus, which could be a single material, but will usually be a textured (e.g. embossed) superstrate layer bonded to a substrate web. The ability to manufacture flake pigment of a specific, pre-determined geometry and size is dependent on the ability to engineer a correctly patterned surface on the substrate. One way of achieving this is to use the technique of micro-embossing where a master shim is used to impart a defined pattern into a photopolymer which is then “frozen” by exposure to ultraviolet radiation; preferably, the photopolymer will be bonded to a UV transparent, polymeric web substrate. The micro-embossing technique can be a reel-to-reel process and therefore inherently suited for the fabrication of very large areas of textured substrate. The preparation of such embossed structures is described for example in WO 96/35971 in the name of Epigem, which relates to the production of micron scale relief structures for generating optical structures, MIM devices, etc. Other ways of generating embossed structures would include the hot embossing of a meltable substrate (e.g. thermoplastic), as opposed to using a secondary photopolymer layer. Other non-embossing techniques for forming textured substrates will also be known to the skilled person, for example, laser micromachining, chemical etching or other suitable surface micromachining techniques.

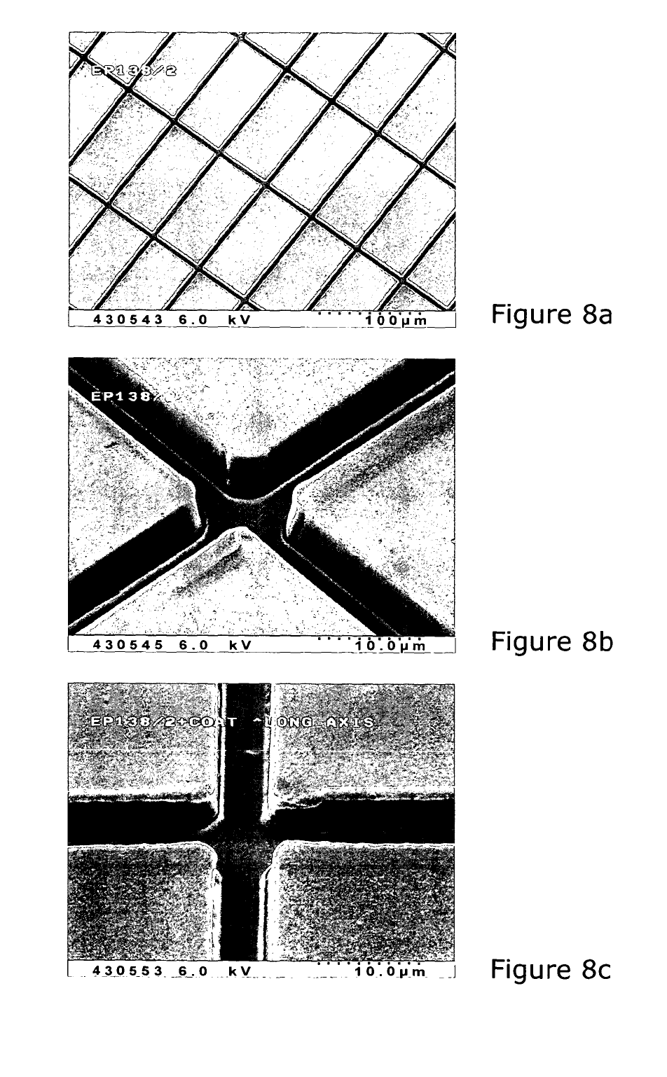

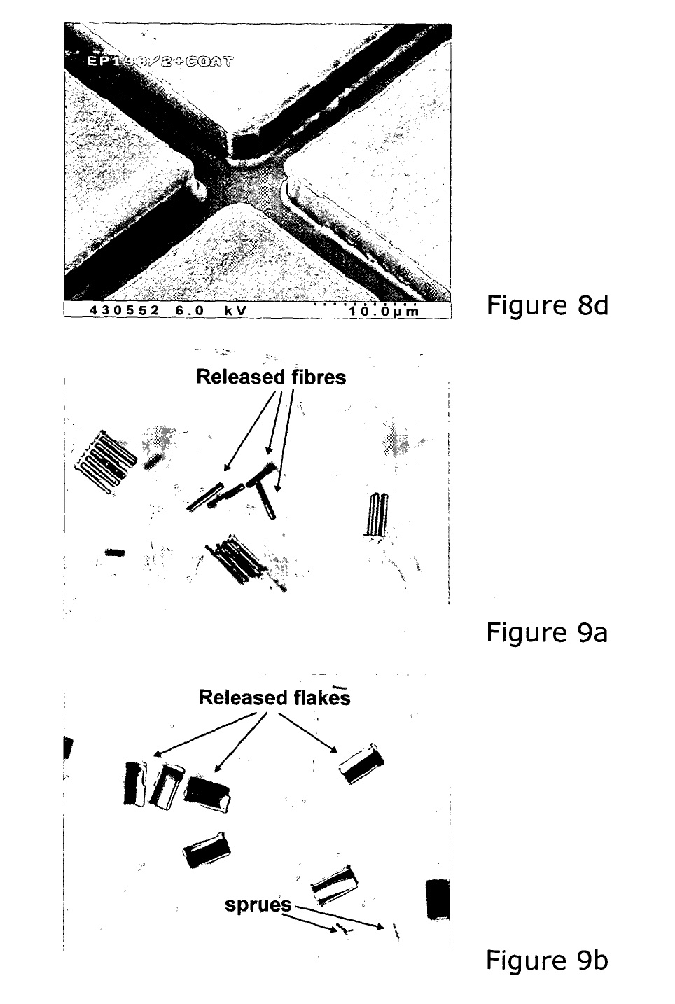

An example of such a textured substrate is shown in FIG. 8b where the photopolymer has been embossed to create 50 μm×100 μm plateaus features separated by 5 μm wide×5 μm deep trenches.

Depending on the nature of the textured/embossed layer and the release agent, it may then be desirable to conduct a wetting treatment upon the embossed layer, for example, a corona discharge treatment and/or employ a wetting agent in the release agent solution.

To ensure that the deposited film can be easily removed from the substrate, a coating of a release agent is next applied (unless exceptionally, the textured structure has inherent release properties). Such a release agent may comprise a dispersion of the synthetic clay mineral Laponite in water. This dispersion is applied to the substrate and then dried which results in a thin coating of Laponite predominantly on raised and lowered plateaus.

In the next step, the film, usually a metallic or inorganic film, is laid down or deposited by any suitable process, and preferably by a vacuum deposition process e.g. sputtering. Sputtering is a form of PVD in which the desired film condenses from a vapour created by bombarding a target of the desired composition by excited atoms of an inert gas.

FIG. 8d shows the same embossed 50 μm×100 μm plateaus substrate with an overcoat of the Laponite release agent. It can be clearly seen that an edge bead, or overhang, has formed at the edge of each plateau, most likely due to surface tension effects. Additionally the release agent is largely absent from the sidewalls of the plateaus structures and again it is postulated that surface tension effects force the aqueous release agent solution to separate out and coat either the top of the plateaus or the base of the trenches. This is depicted schematically in FIG. 2, which also shows the subsequent overcoating of the film. It is believed that that overcoating of film may be interrupted by the edge bead which assists in defining the particle (and sprue) shape and also allows the release solvent access to the release agent.

After overcoating with the metallic or inorganic film, the coated substrate is then immersed in a suitable solvent, water in this case, which dissolves the release agent layer and with the aid of ultrasonic agitation releases the overcoating of film from the substrate. Where necessary, filtration to remove undesired residues or unwanted for example smaller sprue particles may be conducted.

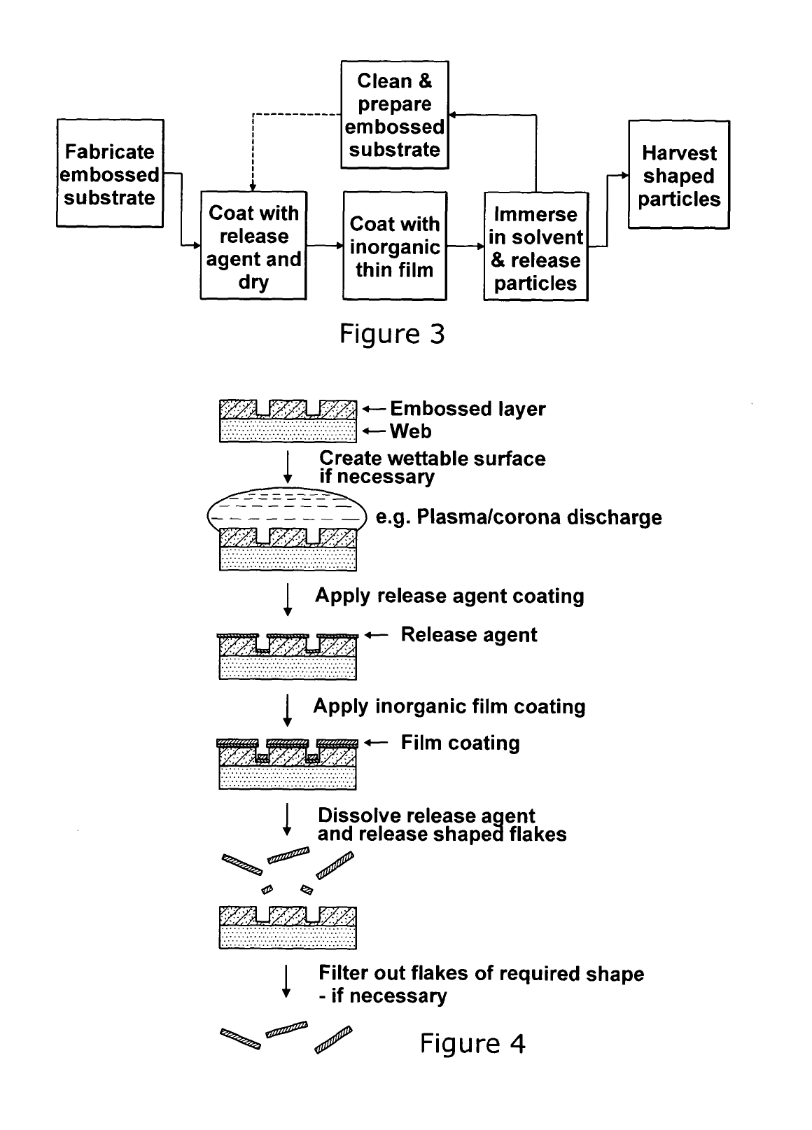

FIG. 3 shows a preferred industrial process for manufacturing shaped flake particles, which may include the initial step of fabricating the embossed substrate in-house and also includes a recycling step of cleaning and re-using the substrate, where especially good release by the release agent is exhibited.

Typically, a preferred industrial process will have the following steps: —

1. Treatment of the temporary, flexible (e.g. polymeric) web substrate to create a textured surface in polymer by embossing—for example by microembossing a photopolymer thereon.
2. Treatment of the embossed surface to improve its wettability for overcoating with a release agent solution—for example either a corona treatment or alternatively by addition of a suitable surfactant to the release agent solution.
3. Treatment of the temporary, flexible (e.g. polymeric) web substrate with a suitable release agent.
4. Reel-to-reel deposition of a thin film (or films) onto the treated web using vacuum technology based on Physical Vapour Deposition (PVD—commonly referred to as sputtering), thermal or ebeam evaporation, chemical vapour deposition or other suitable method.
5. Reel-to-reel stripping of the flakes by dissolving the release agent in a suitable solvent, with the aid of ultrasonic agitation if necessary.
6. Filtration to separate the released flake pigment from the release agent residues and web substrate.
7. Flake sizing check using laser diffraction and/or image analysis to verify optimum particle size/size distribution achieved.

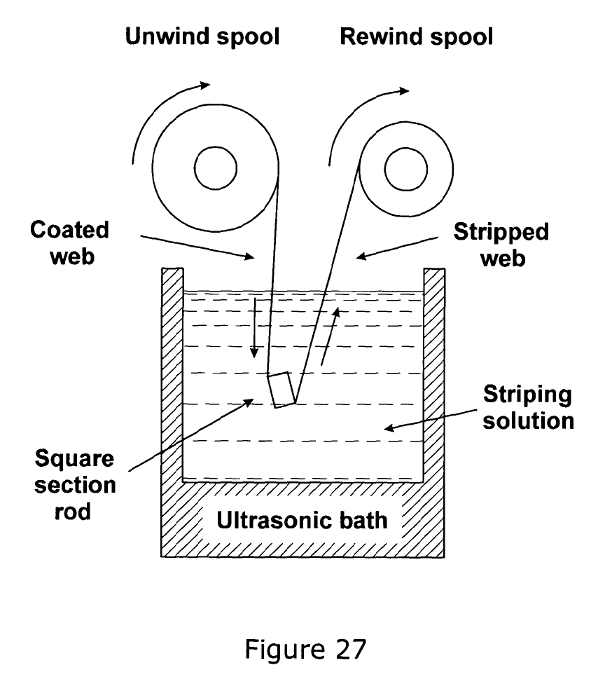

Referring to steps 5 to 7 above, stripping may be carried out by any suitable known technique, batchwise or in a continuous fashion, and with a preferred method being passing the web substrate through a solvent bath using a wind-up roller. In a preferred method, the substrate carrier is passed around a small radius rod, while immersed in a water bath, with ultrasonic agitation. A suitable apparatus is shown in FIG. 27. After stripping, the flakes will usually be correctly separated and of the desired shape and size. However, in certain instances, downstream processing may still be desirable and the flakes may be subjected to separation, filtering and flake sizing processes as would be known to the person skilled in the art. For example, initially filtration may be carried out to separate the released flake from the release agent residues and web substrate. Flake separating operations may include various solvent filtering and drying stages, and may also involve gravity sedimentation, since the flakes will settle in most solvents. Flake sizing operations may include filtering, and agitation and grinding steps, as known in the art. Flake sizing may be checked using laser diffraction and/or image analysis techniques to verify the optimum particle size/size distribution has been achieved.

### Description of Preferred Textured Substrates

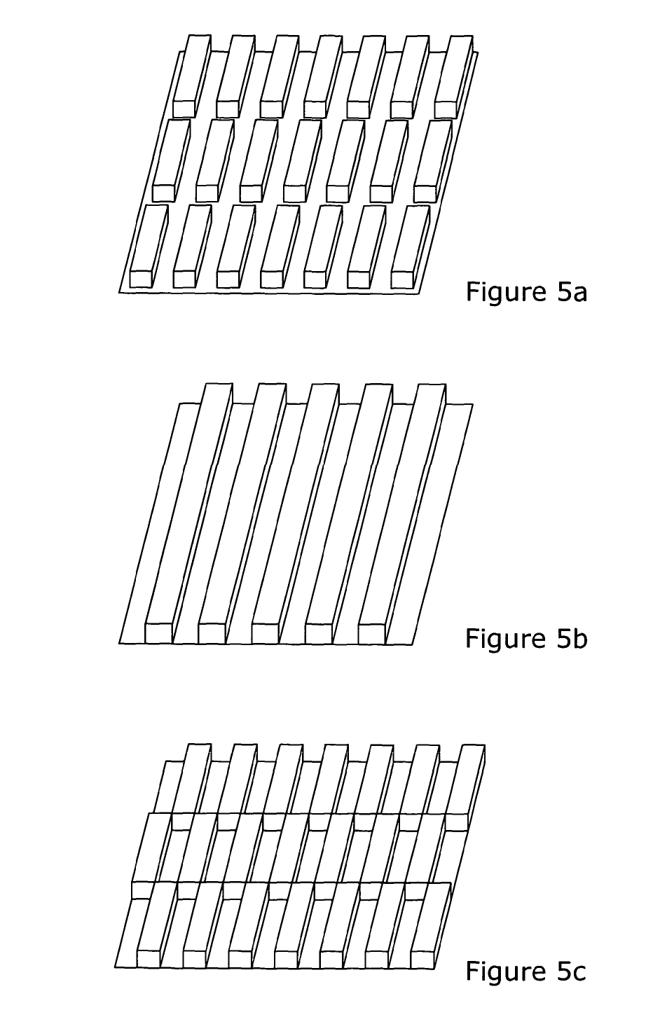

FIGS. 5a, 5b and 5c are respective schematic diagrams of three alternative grid/rib/chequerboard textured substrate designs that are especially preferred and that will be discussed in turn.

Referring first to FIG. 5a, which shows the grid design, the active area of the substrate is formed predominantly of a repeat pattern of raised plateaus of equal size and shape segregated by an interconnecting grid network of lower, narrower trenches.

This design gives higher “shape yield” efficiencies for the larger plateau sizes (relative to the trenches) and good release. The trenches should be as narrow as possible to maximise the yield of useful flake particles. However, even narrow trenches are likely to be coated with a release film, and hence, narrow flake particles, giving rise to a released sprue network of flake particles. Such a sprue network may, however, yield useful high aspect particles and these, if interconnected, may also be broken up by ultrasonic agitation to produce particles of useful dimensions.

### Example 1

### Grid Design Substrate

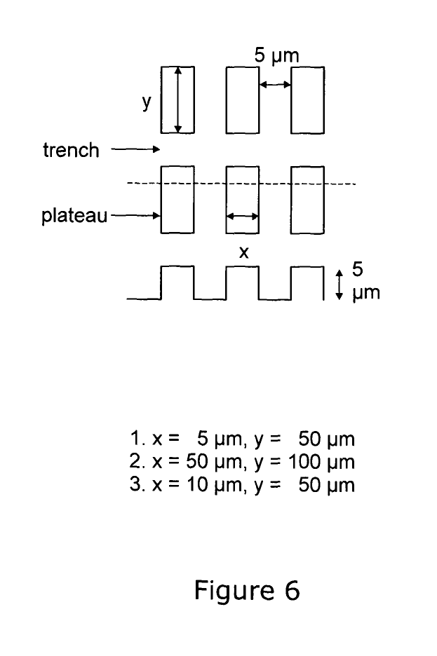

As shown pictorially in FIG. 6, three different substrates using the grid substrate design of FIG. 5a were selected for testing, namely: —substrates with plateau sizes of 5 μm×50 μm, 50 μm×100 μm and 10 μm×50 μm, respectively. The wall angle of the plateaus was designed to be ˜18° from the substrate normal. A trench depth of 5 μm and a trench width of 5 μm was chosen for all designs, which gave nominal shape generation efficiencies of 46%, 87% and 61%, as summarised in Table 1.

TABLE 1

| Particle size (μm × μm) | 5 × 50 | 50 × 100 | 10 × 50 |
|---|---|---|---|
| Particle area (pm²) | 250 | 5000 | 500 |
| Shape yield (%) | 46 | 87 | 61 |

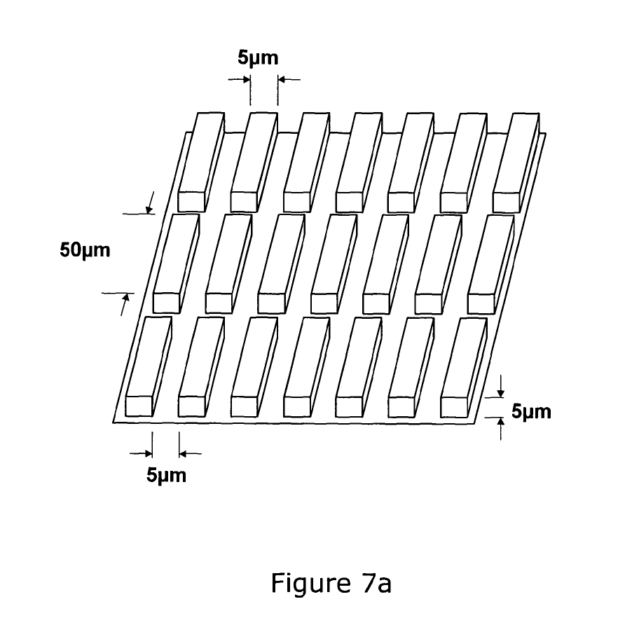

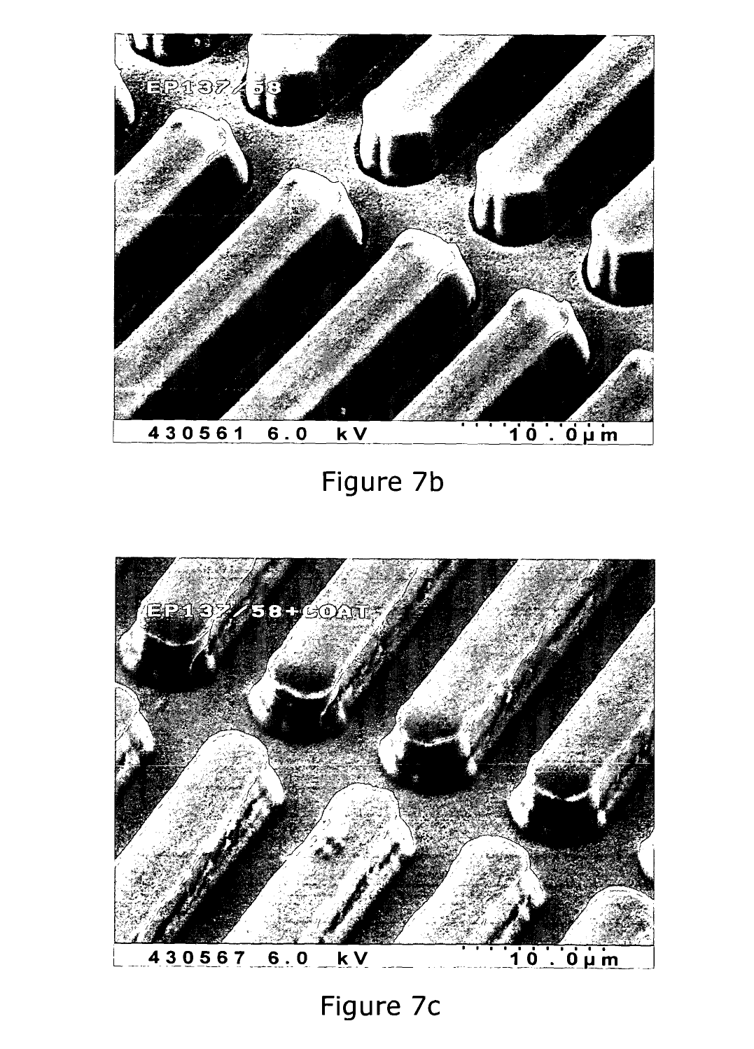

Flat bed embossed substrates were prepared from master embossing shims using an embossable photopolymer resin on a PET substrate. FIG. 7a, for example, shows the grid embossed substrate design with 5 μm×50 μm plateaus (5 μm wide×5 μm deep trenches). Initially, only the 5 μm×50 μm and 50 μm×100 μm embossed substrates were produced and examined by SEM; the results are shown in FIG. 7b and in FIGS. 8 a/b, respectively. The SEM's illustrate the excellent definition obtained by the process. On both structures, but particularly noticeably on the 5 μm×50 μm structures, there is some rounding of the corners of the plateaus—an effect resulting from the particular photolithographic technique used to fabricate the master embossing shims.

The surface of the cured embossing resin was then plasma treated in order to improve the wettability for coating with the release agent solution. A suitable water based, release agent formulation for coating onto the embossed substrates was chosen comprising an aqueous solution of the synthetic clay Laponite, optionally also with the surfactant Synperonic 91/6. This was applied and dried to form a coating of about 0.5 microns thickness

Referring to FIGS. 7c and 8c/d, respectively, these are SEM's of the subsequent release agent coated 5 μm×50 μm and 50 μm×100 μm embossed substrates. They illustrate the “edge bead” type overhang of the release agent coating at the edge of the plateaus and also at the edge of the trenches which is thought to be important in aiding release. The formation of this overhang is thought to be due to surface tension separating out the release agent solution as it dries and forcing it to ‘snap’ onto the plateaus and into the trenches leaving the side walls with little or no coating and also creating a re-entrant structure which may create a break in the subsequently sputtered metal film.

The flake particles were then generated directly, in situ, on the substrates by sputtering a metallic film of Permalloy film (Ni_{0.8}Fe_{0.2}) to a 1 μM thickness. Subsequent to coating with the 1 μm film of Permalloy, the coated substrates were subjected to a standard stripping regime whereby they were bent round a tight radius, and then immersed in tap water with ultrasonic agitation.

FIGS. 9a and 9b are optical micrographs of the 5 μm×50 μm and 50 μm×100 μm shaped flakes released from the substrates of FIGS. 7 and 8, respectively. The target flakes exhibit a monomodal size distribution. The largest flake size 50 μm×100 μm particles released very well and exhibited excellent shape definition and a monomodal size distribution as shown in the SEM of FIG. 9b. In addition to the design shape released from the plateaus areas on the substrate, there was also a proportion of sprue material released—strips around 5 μm wide that result from release of interstitial released flakes from the bottom of the embossed trenches. These were sufficiently different in size to the design flakes that they could be straightforwardly filtered out, if not required.

The 5 μm×50 μm fibres also released well but slightly less readily, with a slightly smaller fraction of the fibres coming off the substrate and a slight tendency to release as small blocks of say four or five still joined particles. This may be due to the high perimeter/area ratio (almost 4× greater than for the 50 μm×100 μm flake) resulting in the fibre having less weight to enable it to pull free or might merely have been due to the fact that the process was at an early stage of development. In addition, during the fabrication of the embossed substrates a degree of stiction was found to occur on the 5 μm×50 μm samples, probably due to a combination of the emboss depth (5 μm) and the low plateau area to emboss area ratio.

Accordingly, the intermediate size 10 μm×50 μm substrate was produced and flake particles also generated therefrom. Release trials using embossed substrates with this intermediate plateau size, but the same emboss depth as used previously, were successful in providing good yield of the target particle size, and an increase in shape generation efficiency from 46% to 61%, as well as significantly reduced stiction between the shim and photopolymer.

The grid design was therefore found to be effective in generating thin film flake of a precisely controlled size and shape. While interstitial material from the base of the trenches has also been released, since this is very different in size/shape to the target flakes it can be straightforwardly filtered off and either retained, if a useful size/shape, or discarded. Certainly it may be possible to engineer the embossed substrate to give usefully shaped & sized flakes which are released from both the top and bottom of the embossed relief.

### Example 2

### Rib/Chequerboard Textured Substrate Designs

The necessary presence of the trenches in the grid design decrease the shape yield efficiency for smaller flake sizes, and hence, an alternative design was devised that was capable of higher efficiency for smaller flake sizes.

Two alternative embossed substrate designs were devised. These trial designs are termed continuous rib and chequerboard patterns and are illustrated schematically in FIGS. 5b and 5c, respectively. The continuous rib design makes the plateaus continuous in the long dimension and rely on subsequent processing to break the released strips of material into fibres of around the required size. Alternatively, notches or transverse, raised or indented cross-bars may be incorporated at regular intervals along the ribs during micro-embossing to provide lines of weakness. In addition the trenches (lowered plateaus) are similarly sized to the raised plateaus and, assuming that sprue material is released, would contribute equally useful material—thereby potentially increasing the particle generation efficiency from the substrate.

In the second design comprising the chequerboard, the sprue framework is again dispensed with, and the design aims to generate equal sized particles of the required final geometry directly using raised and sunken plateaus of equal dimension alternating in two orthogonal directions in the plane of the substrate. It was hoped that this would encourage the release of particles of the required shape and size from both the top and bottom of the substrate.

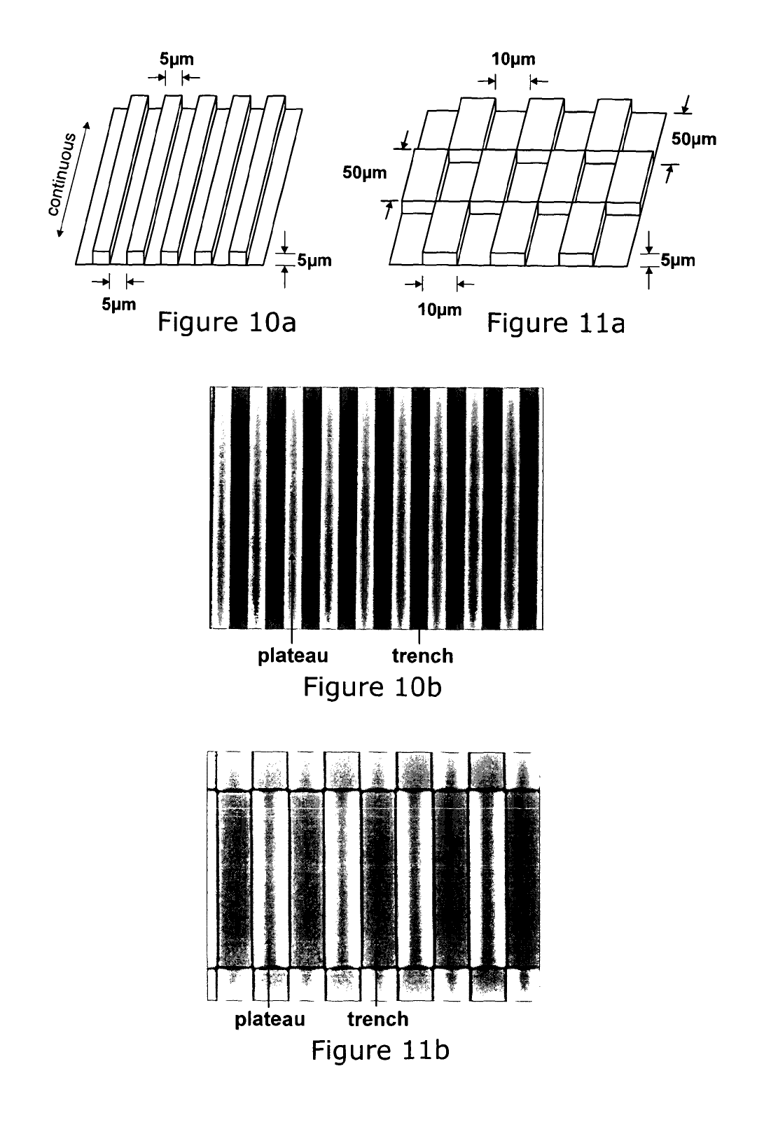

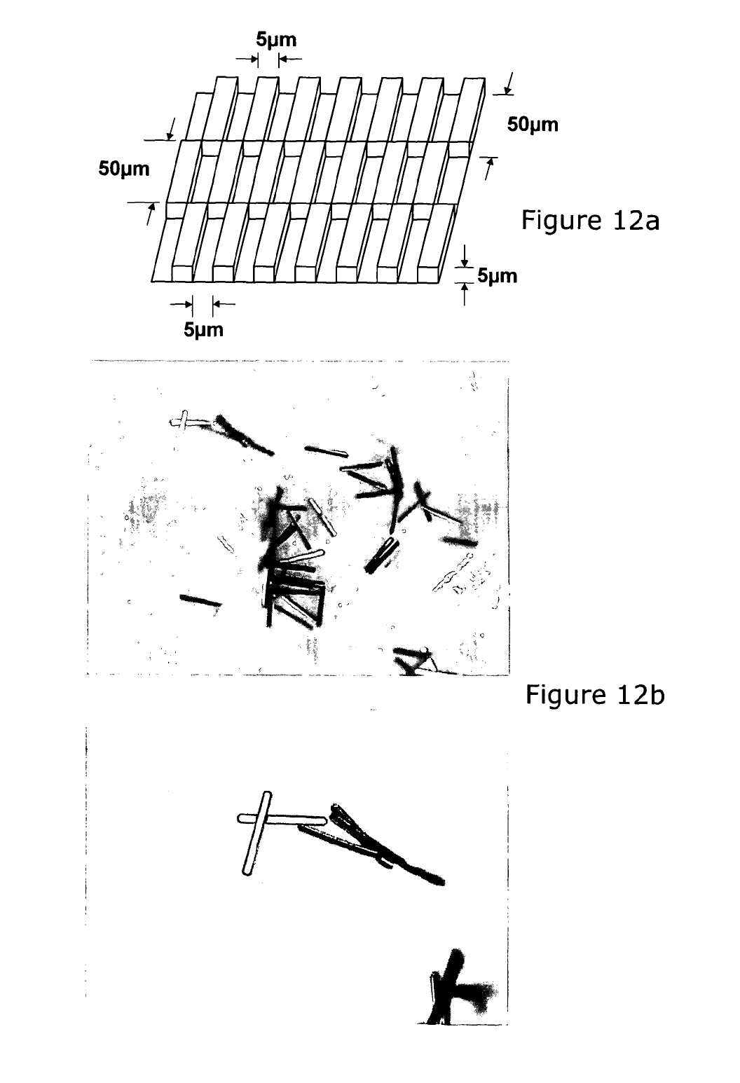

Embossed substrates, of the two designs, were manufactured with a target emboss depth of 5 μm, into a 10 μm thick overcoat of uv curable resin coated onto a flexible 36 μm thick PET substrate. FIG. 10a is a schematic diagram of a continuous rib, 5 μm width/depth/repeat, embossed substrate design, and FIG. 10b is an optical micrograph of the corresponding embossed substrate where the ribs were about 12 cm long. Similarly, FIG. 11a is a schematic diagram of a chequerboard, 10 μm×50 μm plateaus, embossed substrate design, and FIG. 11b is an optical micrograph of the corresponding embossed substrate. The emboss quality was excellent with both designs having an emboss depth close to the design value of 5 μm.

FIG. 12a is a schematic diagram of a further, continuous chequerboard, embossed substrate design with smaller, 5 μm×50 μm plateaus. A corresponding substrate of this design was similarly manufactured. This led to the following variants being available for particle release studies: —
5 μm trench, 5 μm plateau continuous rib
10 μm×50 μm chequerboard
5 μm×50 μm chequerboard—motif raised * (small gaps between plateaus) *While all designs are symmetrical at the photomask stage, assymetries tend to be introduced into the chequerboard pattern due to imperfections in the photolithography process—principally the rounding of sharp corners—resulting in either minute connections or gaps between plateaus depending on the sex of the embossing shim.

The test substrates were coated with a release agent formulation using a Meyer bar (or K-bar) to give a ˜12 μm wet coat thickness and a corresponding dry coat thickness of ˜0.5 μm. The formulation comprised Laponite, and a polymeric surfactant in order to aid the wetting of the solution onto the substrate. A 1 μm thickness of Permalloy (Ni_{0.8}Fe_{0.2}) was then sputter coated onto the substrates.

Small scale stripping of the coated substrates was carried out using a bench top ultrasonic bath. First the coated substrate was bent through a tight radius rod to aid release, before being placed in a beaker of tap water which was then placed in the ultrasonic bath. The water serves to re-hydrate the laponite coating, which reverts from a solid dry film to a suspension, while the ultrasonic agitation is intended to encourage the shedding of the shaped particles. The results of the release study are summarised in Table 2 below.

TABLE 2
Summary of release study results for different substrate designs

| Sample | | |
|---|---|---|
| Number | Format | Observations |
| EP154/8/11 | 5 μm | Excellent release of Permalloy film |
| Flake 1 | continuous rib | from both plateaus and trenches on the |
| | | substrate as variable length 5 μm width |
| | | flakes. Some curling up of flakes. |
| EP154/8/12 | 10 μm × 50 μm | Excellent release of Permalloy film |
| Flake 2 | chequerboard | from both plateaus and trenches on the |
| | (small | substrate. |
| | connections) | |
| EP154/18/2 - | 5 μm × 50 μm | Efficient release of Permalloy film, |
| motif raised | chequerboard | but releases more readily from raised |
| | (small gaps) | than lowered plateaus |
| | | Released particles exhibit excellent mono- |
| | | modal size distribution - see FIG. 12b. |

The results of the release study were very encouraging. The 5 μm×50 μm chequerboard designs (motif raised) exhibited an excellent mono-modal size distribution, as shown in the two optical micrographs of FIG. 12b.

It will be noted that the continuous rib flakes exhibited some curling along their length. These were generated perpendicular to the web and some were of considerable length. This was consistent with other observations where untextured substrate at the sides of the web generated randomly shaped flakes which also exhibited curling due to stress effects in the (stretched) continuous film. It would appear that discrete flakes of a limited length (not more than 100 microns) also have the advantage that their discrete nature allows the material to “relax”, which means they are surprisingly flat upon release.

### Example 3

In this Example, methods of improving the wetting of the substrate were investigated.

(i) Corona discharge treatment: —A release agent coating formulation comprising: 2900 gm Deionised water, 89.4 gm Laponite RD and 100 gm of a surfactant Synperonic 91/6 (20%) was sprayed using a spray gun onto an embossed substrate comprising a sheet of 125 micron Melinex ST 505, half of which was corona treated and half left as made. This coating gave perfect wetting to the corona treated half of the embossed pattern, but on the non-corona treated half of the embossed structure, many retraction spots were observed indicating poor wetting.
(ii) Corona discharge/surfactant treatment: —A small scale study was carried out to investigate the efficacy of corona discharge treatment for improving the wettability of the embossed substrate to the release agent solution. Foaming of the release agent solution during application, thought to be due to the surfactant additive used to aid wetting, has been previously found to limit the throughput speed of the web—which would increase production costs. An alternative way of achieving this wetting is to corona discharge the embossed web which alters the surface chemistry to hydrophilic.

Flat embossed substrates with the 5 μm×50 μm chequerboard pattern were used for this study, the underlying substrate being 125 μm PET. Corona discharge treatment was carried out prior to coating with one of two release agent formulations, one with a surfactant, and one without any surfactant. The corona discharge settings varied from 5 m/min, 15 m/min to the fastest setting 25 m/min, which gave a minimal treatment.

The release agent coatings were applied to the substrates using 6 μm, 12 μm, 24 μm and 36 μm Meyer bars with the bar hand drawn in a direction parallel to the long axis of the embossed pattern. Coated sheets were dried on a flat glass sheet in an oven at 120° C. Details of the coated substrates, and brief qualitative notes on the quality of coating achieved, are given in Table 3.

TABLE 3
Test embossed substrates, shaded rows indicate samples
overcoated with 1 μm of Permalloy for stripping trials.

| | | Ragent | Drying time | Corona | |
|---|---|---|---|---|---|
| Sample | | Coating | at 120° C. | setting | |
| number | Surfactant | (wet, μm) | (min) | (m/min) | Notes |
| EP154/39/1 | ✓ | 6 | 2 | none | Poor coverage so conducted a second pass |
| EP154/39/2 | ✓ | 6 | 2 | none | Slower Meyer bar speed, better coverage |
| EP154/39/3 | ✓ | 12 | 2 | none | Good coverage |
| EP154/39/4* | ✓ | 12 | 2 | none | Good coverage - used as control sample |
| EP154/39/5 | ✓ | 24 | 2 | none | Poor coverage, requires flooded Meyer bar |
| EP154/39/6 | ✓ | 24 | 3 | none | Suspect coverage |
| EP154/39/7 | ✓ | 36 | 3 | none | Poor coverage - coating too thick to control |
| EP154/39/8 | ✓ | 12 | 2 | none | Poor coverage |
| EP154/39/9 | ✓ | 12 | 2 | none | Poor coverage |
| EP154/39/10 | ✓ | 12 | 2 | none | Poor coverage |
| EP154/39/11* | ✓ | 12 | 2 | 5 | Good coverage |
| EP154/39/12 | x | 12 | 2 | 5 | Good coverage |
| EP154/39/13* | x | 12 | 2 | 5 | Good coverage |
| EP154/39/14 | x | 12 | 2 | 15 | Good coverage |
| EP154/39/15 | ✓ | 12 | 2 | 15 | Good coverage |
| EP154/39/16* | x | 12 | 2 | 15 | Good coverage |
| EP154/39/17 | ✓ | 12 | 2 | None | Poor coverage |
| EP154/39/18 | ✓ | 12 | 2 | 25 | Good coverage |
| EP154/39/19* | ✓ | 12 | 2 | 25 | Good coverage |
| EP154/39/20 | x | 12 | 2 | 25 | Very poor coverage |

It can be seen that use of corona discharge treatment (on all but the fastest setting of 25 m/min c.f. EP154/39/20) results in excellent wetting of the surfactant-free release agent onto the embossed substrate. Corona discharge treatment of the substrate is therefore a valid alternative to the inclusion of surfactant in the release agent solution, with equally effective particle release observed.

The shaded areas* in Table 3 denote samples with good wetting by the release agent coating and these were subsequently overcoated with ˜1 μm of Permalloy.

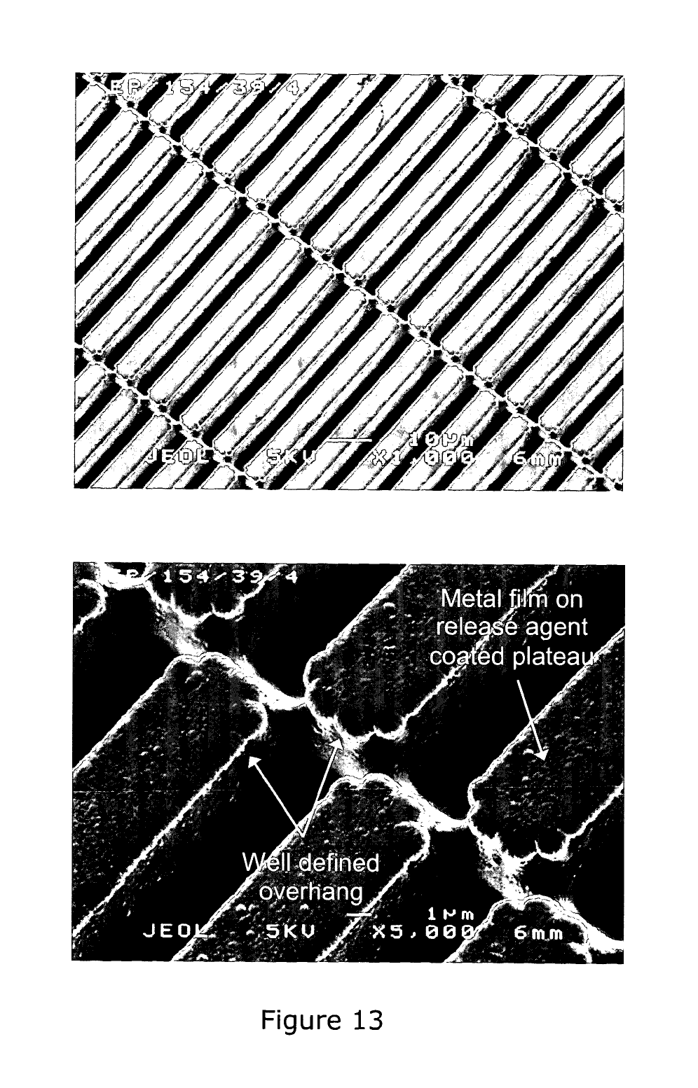

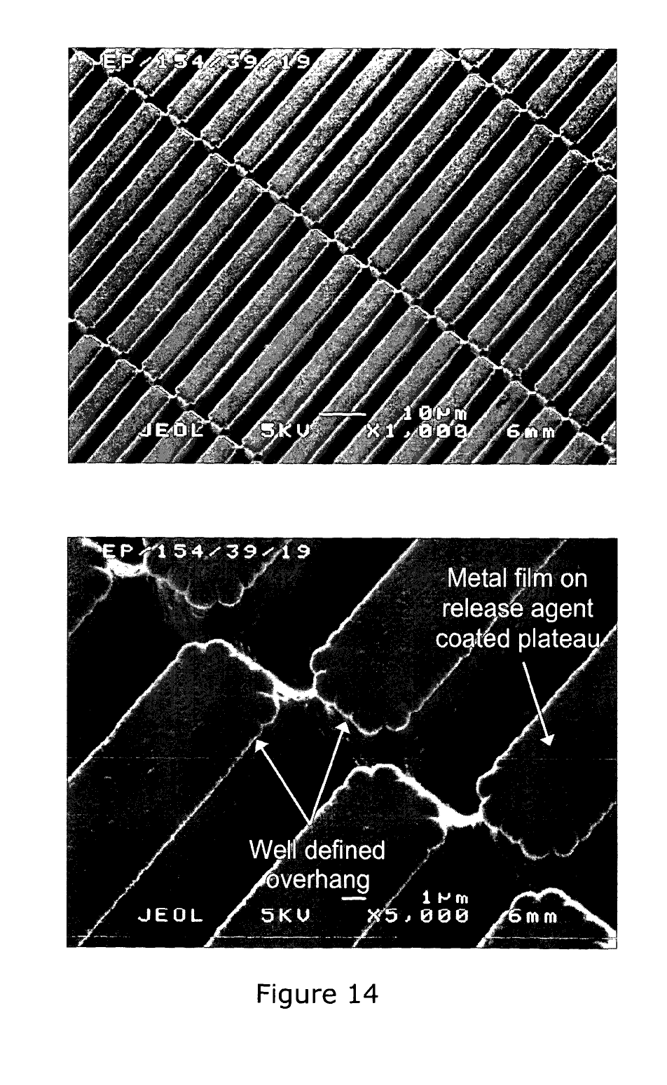

SEM micrographs of Permalloy overcoated substrates are shown in FIG. 13 (EP154/39/4—release agent with surfactant only) and FIG. 14 (EP154/39/19—corona treated, release agent with surfactant). In both cases there is a clear separation between the plateaus, caused by loss of definition in the photolithography process, and (on the plateaus) a well defined overhang of the release agent and metal coating due to the edge bead formed when the release agent is dried. The Permalloy film is therefore delineated into individual metal flakes.

Particle release studies were carried out using the method of immersion of the coated substrates in water, after being passed around a small rod with ultrasonic agitation. The results are briefly summarised in Table 4:

TABLE 4
Summary of release trials on test substrates

| | | Release | | |
|---|---|---|---|---|
| | | agent | Corona | |
| Sample | Surfac- | coating | setting | |
| number | tant | (wet, μm) | (m/min) | Notes |
| EP154/39/4 | ✓ | 12 | none | Released quickly. Released |
| | | | | particles very well sized. |
| EP154/39/11 | ✓ | 12 | 5 | Lost during deposition. |
| EP154/39/13 | x | 12 | 5 | Released quickly. Released |
| | | | | particles very well sized. |
| EP154/39/16 | x | 12 | 15 | Released quickly. Released |
| | | | | particles very well sized. |
| EP154/39/19 | ✓ | 12 | 25 | Released quickly. Released |
| | | | | particles very well sized. |

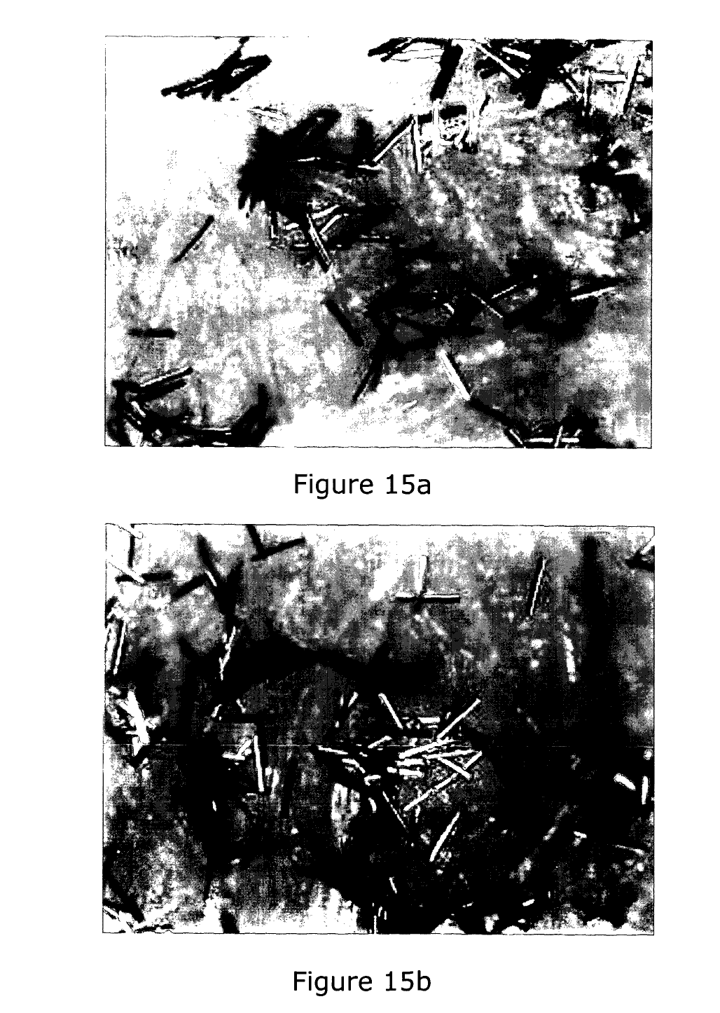

Single flake particles released well from the plateaus. FIGS. 15a and 15b are, respectively, optical micrographs of the released Permalloy particles from sample EP154/39/4 (surfactant treated) and sample EP154/39/13 (corona treated) clearly showing the monomodal distribution.

### Example 4

In this example, other thin film materials were trialled. Flake particles were generated from two commercially available, soft magnetic alloy films, Atalante® CoFeSiMoB and Atalante® CoZrNb film.

The roll substrate was a 36 μm thick non-heat-stabilised PET film coated with a 10 μm coating of embossed uv-curable acrylic resin embossed to a 5 μm depth. Wettability was improved using a corona discharge treatment on the substrate, or by incorporating a surfactant in the release agent solution. In a separate run, a 12 μm wet coat of the laponite-based release agent solution was applied with a bead coater, which gave a 0.5 μm dried coating of release agent.

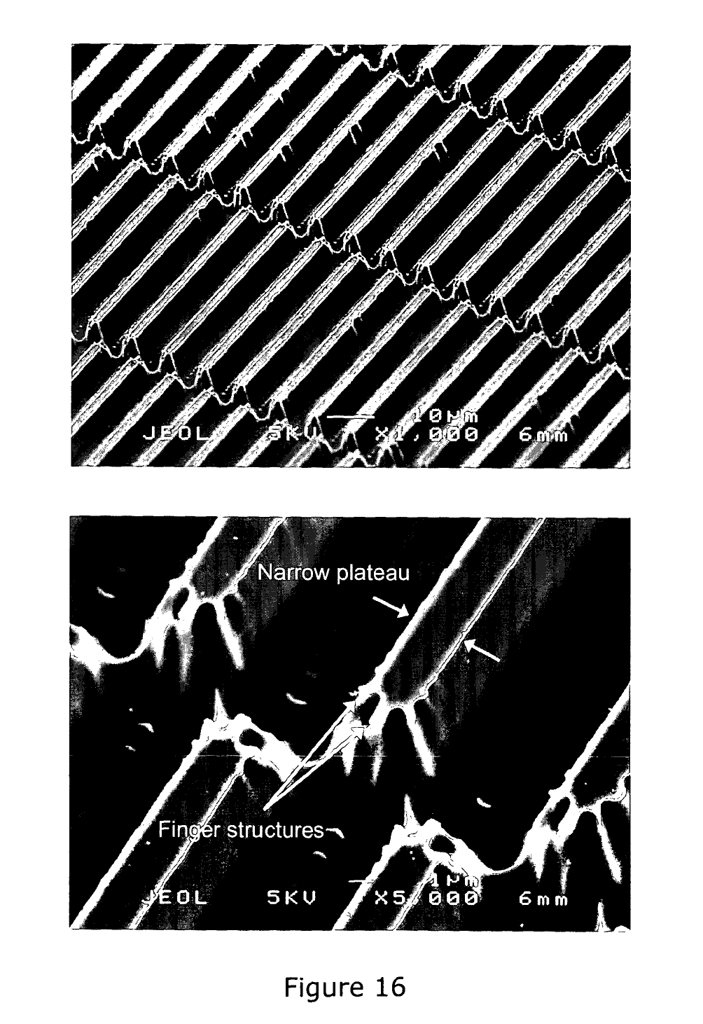

This trial was to be conducted on an industrial scale (e.g. using 100 m sections of web substrate) and substrate of a new embossed design was manufactured. For large area substrate production large embossing shims were needed to fabricate the embossing roller. This in turn led to a change in the embossing procedure which resulted in narrower width for the raised plateaus of ˜2.5-3 μm and wall angles of ˜15°. This may be seen in the FIG. 16 SEM micrographs of the ˜3 μm×50 μm chequerboard embossed web substrate. There was also a tendency for the formation of finger structure artefacts, as may be seen in those Figures.

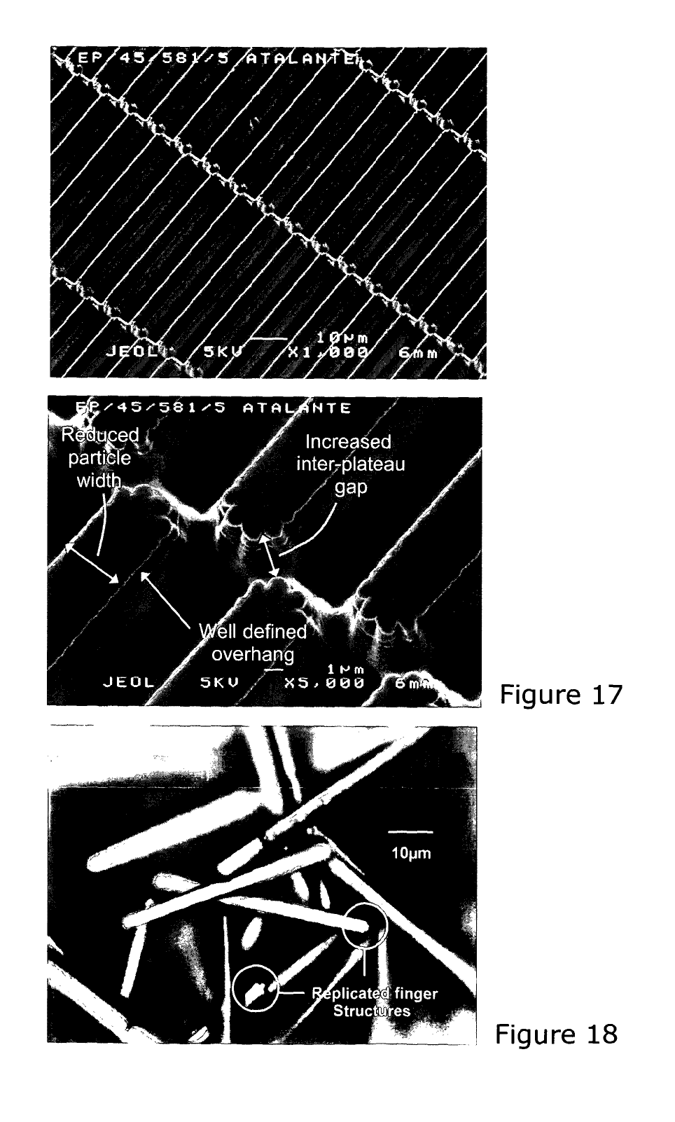

(i) The Atalante® CoFeSiMoB film was coated in its standard thickness of 1 micron on the above substrate. The release agent included a surfactant for wetting and no other wetting treatment was used. FIG. 17 shows two SEM micrographs of the substrate coated with Atalante® CoFeSiMoB film. It can be seen that a well defined overhang has been achieved around the raised plateaus; the reduced particle width is also evident. Other thicknesses of film were also laid down (0.8, 0.9, 1.1, 1.2 microns) and the respective sections subjected to standard stripping. The results are summarised in Table 5 below. Optical microscope examination of the stripped product was used to assess the proportion of single particle release and block release.

TABLE 5
Summary of trial stripping results for Atalante ® CoFeSiMoB film

| Atalante | |
|---|---|
| CoFeSiMoB | |
| thickness | Notes |
| −20%, 0.8 μm | Good single particle release and minimal |
| | block release. |
| −10%, 0.9 μm | Good single particle release and minimal |
| | block release. |
| 0%, 1 μm | Good single particle release and minimal |
| | block release. |
| +10%, 1.1 μm | Good single particle release and minimal |
| | block release. |
| +20%, 1.2 μm | Good single particle release but a high |
| | proportion of block release of sprue |
| | material from the trenches. |

Generally, there was good single particle release and minimal block release. The thinnest film appeared to release more slowly, while the extra thickness of the 1.2 micron film appeared to engender the sprue with greater mechanical strength making it more likely to release and, having done so, not break up (with the agitation power of the bath used).

FIG. 18 is an optical micrograph of the released Atalante® CoFeSiMoB film particles illustrating the replication of the micron scale ‘finger’ features from the embossed substrate.

(ii) The Atalante® CoZrNb film was coated by a similar process on one substrate that had been corona discharge treated and another that had not, but that had included a surfactant in the release agent solution.

TABLE 6
Summary of trial stripping results for Atalante ® CoZrNb

| | |
|---|---|
| CZN | |
| thickness | Notes |

Roll 1 (corona discharge treatment, no
surfactant in release agent solution)

| | |
|---|---|
| +33%, 1 μm | Optical microscope examination of the stripped product |
| | shows good proportion of single particles. |

Roll 3 (no corona discharge treatment,
surfactant in release agent solution)

| | |
|---|---|
| +33%, 1 μm | Optical microscope examination of the stripped |
| | product shows good single particle release |
| | and minimal block release. |

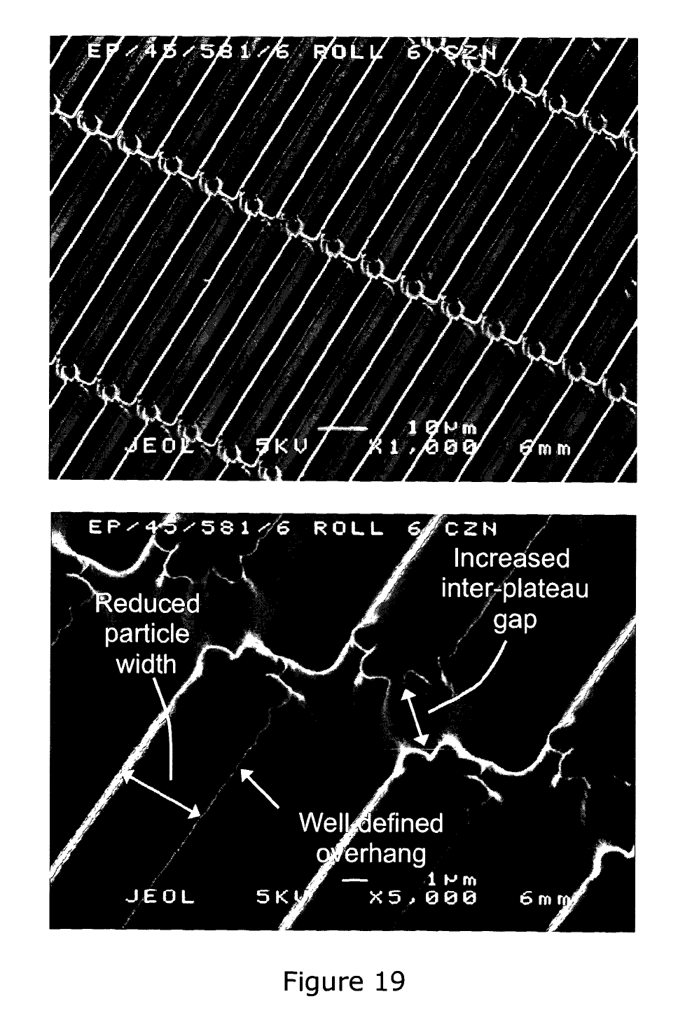

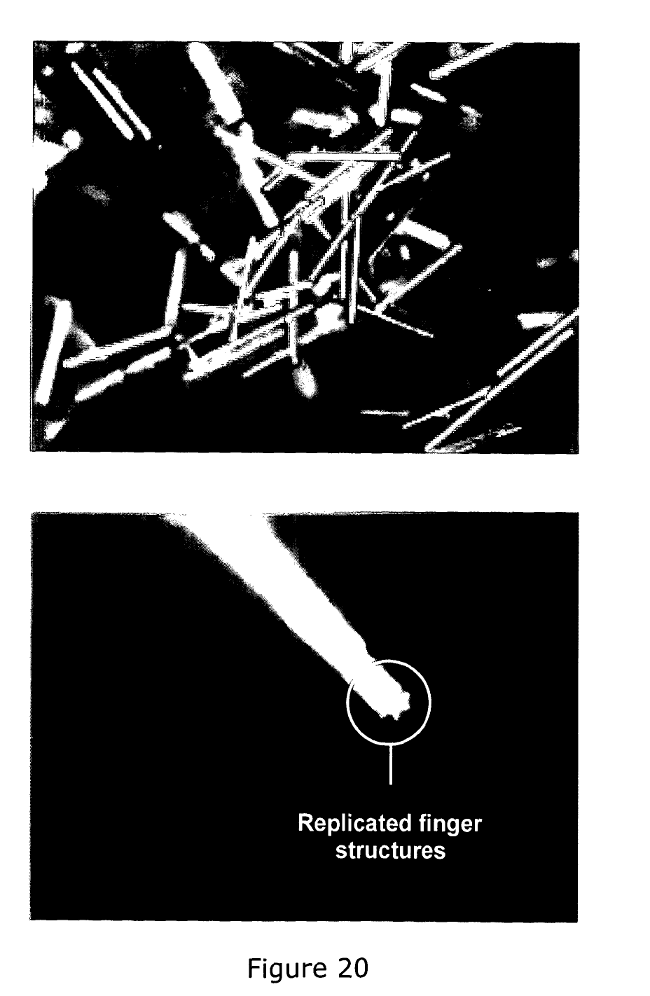

The film was deposited to a thickness of 1 micron, which is 33% above its standard thickness and this allowed a good proportion of single particles to be released. FIG. 19 shows two SEM micrographs of the Atalante® CoZrNb and release agent (with surfactant) coated substrate. The detailed picture shows the definition of the deposited film into individual particles, on the plateau tops, via the overhang created by the edge beading of the dried release agent. As observed for the other Atalante® film, the substrate ‘finger’ structures have been replicated on the elongate particles, demonstrating that the particle formation technique is capable of replicating micron-scale features. Finally, referring to FIG. 20, this shows two optical micrographs of the released Atalante® CoZrNb film particles, again illustrating the replication of the micron scale ‘finger’ features from the embossed substrate, as well as the mono-modal distribution.

### Example 5

In this example, alternative release agents to Laponite RD were trialled, including water soluble and organic solvent based release agents. Alternative flake materials to magnetic alloys were also trialled, and an alternative technique used for depositing the flake material.

The substrate used was a flat bed (as opposed to roll-to-roll) embossed substrate of the grid design having a surface delineated into 5 μm wide×5 μm deep trenches and 50 μm×100 μm plateaus with a ˜17° trench side wall angle. This structure was embossed into a UV-cured acrylic resin coated onto 36 μm thick PET, as previously described and depicted in FIGS. 8a and 8b of Example 1.

Alternative release agents were trialled to see if they could be successfully applied to a textured substrate, and would enable the subsequent release of shaped particles.

They were initially assessed for their miscibility in either water or organic solvent (MEK), as appropriate, and their ability to form a thin film upon application to a polymer substrate. Table 7 gives a summary of the results for LG156 PMMA (MEK soluble), Sodium Tetraborate (“Borax”, water soluble), PVA (adhesive, water soluble) and polyacrylamide (water soluble), which all proved suitable: —

TABLE 7
Summary of assessment of various release agent materials

| | | | | Film |
|---|---|---|---|---|
| | Solubility | Solubility | Wetting | forming |
| Material | in water | In MEK | treatment | ability |
| LG156 PMMA | | Yes | No | Yes |
| Sodium | Yes | | corona | Streaky |
| tetraborate | | | | film |
| PVA | Yes | | corona | Yes |
| Polyacrylamide | Yes | | surfactant | Yes |

Diakon™ LG156 PMMA (Poly (methyl methacrylate)), in particular, exhibited good solubility in MEK and good film forming ability and did not require a wetting treatment.

Release agent coated textured substrates were then fabricated using Laponite RD and selected materials from Table 7 as release agents.

The release agents were made up into either water or MEK solutions, applied as a ˜12 μm thick wet coat using a Meyer (or K) bar and subsequently dried in an oven at 90° C. for a few minutes to give a dry coat of ˜0.5-0.6 μm thickness. To aid the wetting of the release agent coating onto the embossed substrates, some substrates were either corona treated (using an atmospheric pressure corona discharge) or a surfactant was added to the release agent solution.

The following release agent coated substrates were prepared and are summarised in Table 8.

TABLE 8
Summary of coated substrates

| Sample ID | Release agent material | Wetting treatment |
|---|---|---|
| EP157/30/1 | Laponite RD | surfactant |
| EP157/30/2 | | |
| EP157/30/3 | Laponite RD | corona |
| EP157/30/4 | | |
| EP157/30/5 | Borax | surfactant |
| EP157/30/6 | | corona |
| EP157/30/7 | Polyacrylamide | surfactant |
| EP157/30/8 | | corona |
| EP157/30/9 | PMMA (LG156) | none |

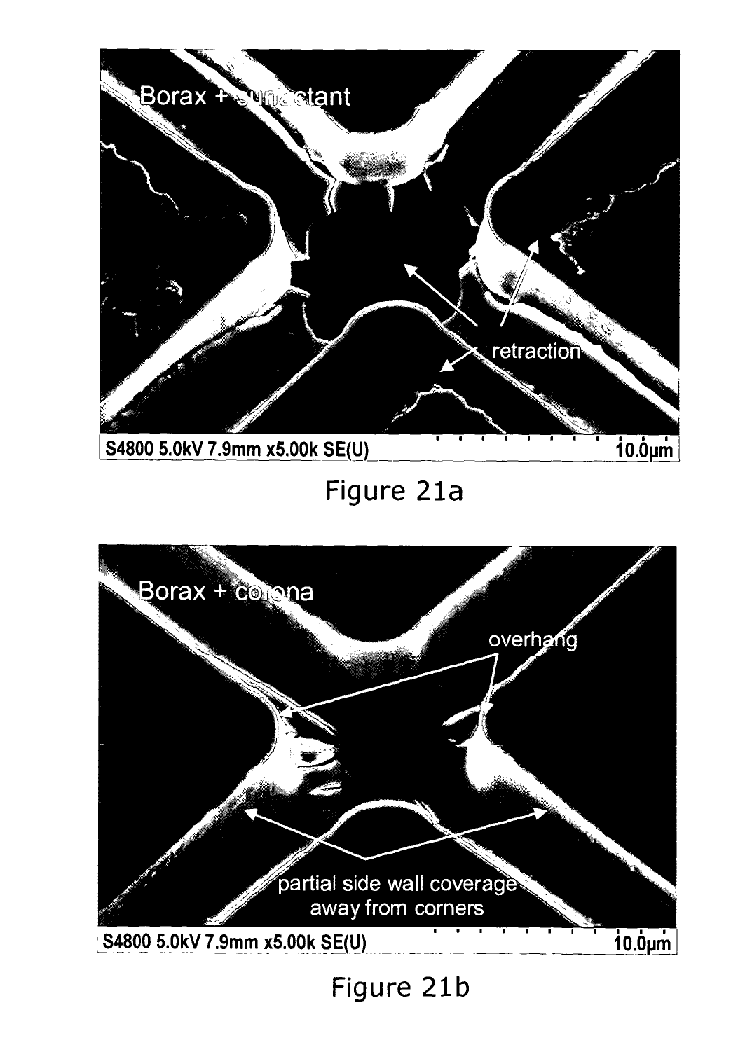

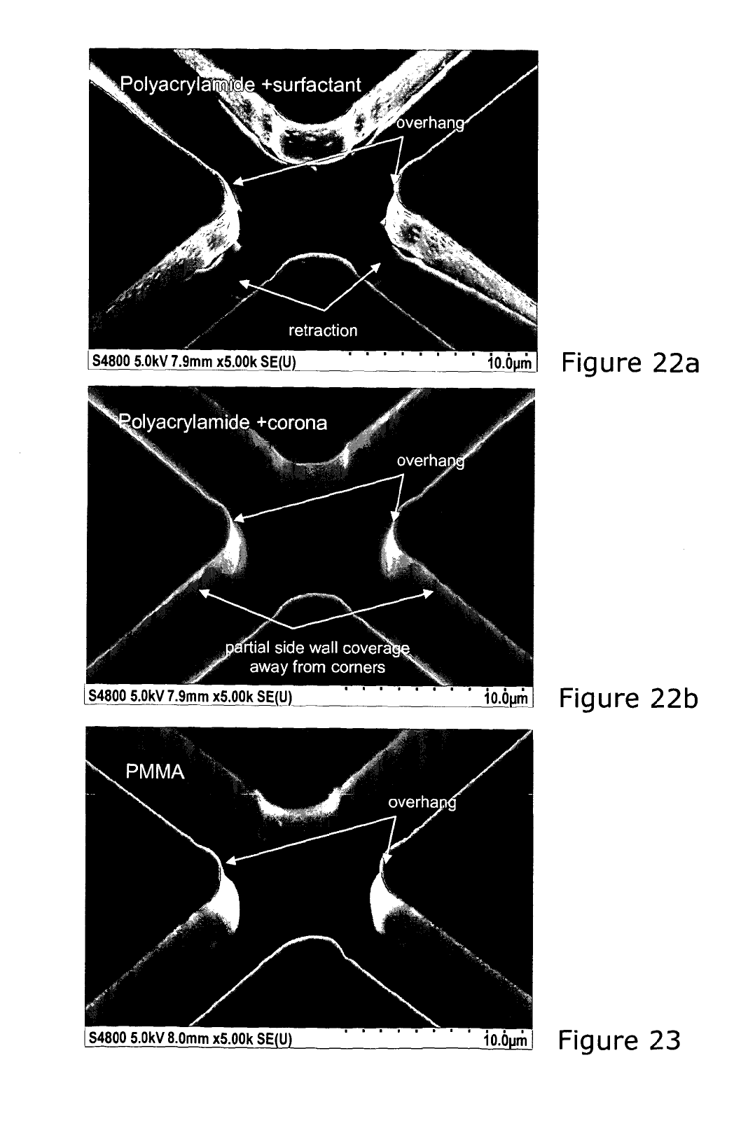

The (dry) release agent coated substrates were subject to detailed SEM examination, with FIGS. 21 to 23 showing images of certain samples. To summarise: —
The Laponite RD coated substrates exhibited good apparent coverage of the plateau tops and (trench) bottoms, for both surfactant and corona variants, and also the development of the overhang feature thought to be important in the release process.
FIGS. 21a and b respectively show SEM images of Borax coated embossed substrates with wetting treatments of (a) surfactant and (b) corona. The surfactant variant of the Borax coated substrate exhibited undesirable retraction of the release agent coating from the plateau edge whilst the corona variant looks to have coated both the plateaus well, with possible evidence of an overhang feature. The level of coating in the trenches appears to be variable with no or minimal side-wall coating at the embossed feature corners and steadily increasing (though not completely to the plateau tops) side wall coating away from the corners.
FIGS. 22a and b respectively show SEM images of Polyacrylamide coated embossed substrates with wetting treatments of (a) surfactant and (b) corona. The polyacrylamide coated samples exhibit good coverage of the plateau tops, with apparent overhang, for both variants. Partial retraction of the release agent coating from the trench floors, at the intersections, is observed for the surfactant variant, with the degree of side wall coating appearing to increase away from the intersections. For the corona variant no release agent retraction was observed.
FIG. 23 shows SEM images of PMMA (LG156) coated embossed substrate. The PMMA coated sample appears to have coated very well with excellent apparent coverage of the plateau's, with apparent overhang, and trench floors. From the SEM pictures it is not clear to what extent, if any, the side walls have been coated.

After release agent coating, the substrates were then overcoated with a metal layer via physical vapour deposition techniques, namely either thermal evaporation or sputtering. In the machine configurations used, the thermal evaporation process is essentially a room temperature process while the sputtering process is somewhat above room temperature—the latter possibly having affected the performance of some of the release agent materials.

The substrates were coated with thermally evaporated aluminium, with sputtered permalloy (Ni_{0.8}Fe_{0.2}), and with a sputtered non-magnetic AgAu alloy (Ag_{0.85}Au_{0.15}), the first being a pigment industry standard material/method.

To assess the efficacy of the potential release agent materials, the overcoated samples were then subjected to stripping. For this a ˜1″×1″ piece was cut out, passed around a narrow rod and then placed in ultrasonically agitated (Ultrawave U50 ultrasonic bath) release solution—either water or MEK (Methyl Ethyl Ketone, or butanone), depending on the material. If stripping was successful, then released particles were collected in a Pasteur pipette and deposited on filter paper for detailed examination using an optical microscope.

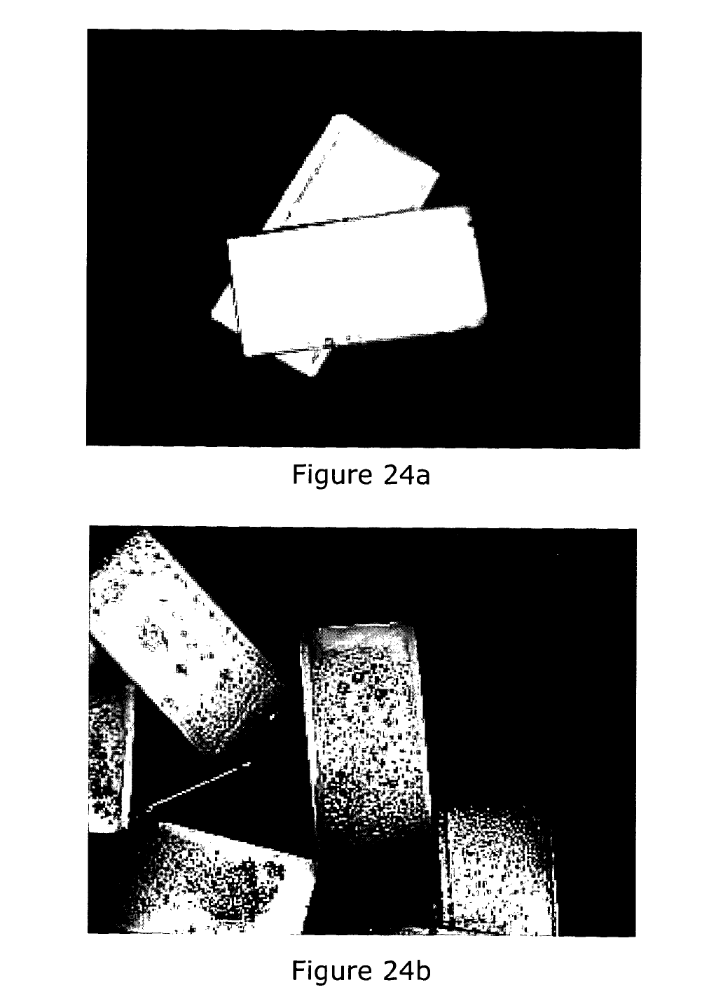

Results of the release trials are summarised in Tables 9 to 12 with optical micrographs of a selection of the released particles shown in FIGS. 24 to 26, as identified in the right hand column.

TABLE 9
Summary of release studies using Laponite RD

| | | | | Shaped | |
|---|---|---|---|---|---|
| | Release Agent + | | Stripping | particles | |
| Sample ID | wetting treatment | Overcoat | medium | generated | Comments |
| EP157/30/1 | Laponite RD + | Evaporated | water | ✓ | Release of shaped |
| Quadrant B | surfactant | Al | | | particles but tend to |
| | | ~240 nm | | | be damaged - film |
| | | | | | too thin for area? |
| EP157/30/1 | | Sputtered | water | ✓ | Efficient and quick |
| Quadrant C | | Permalloy | | | release of shaped |
| | | ~1 μm | | | particles & sprues. |
| EP157/30/1 | | Sputtered | water | ✓ | Quick and efficient |
| Quadrant A | | AgAu | | | release of shaped |
| | | ~1 μm | | | particles & sprues, |
| | | | | | small proportion of |
| | | | | | breakages. |
| EP157/30/3 | Laponite RD + | Evaporated | water | ✓ | Efficient and quick |
| Quadrant B | corona | Al | | | release of shaped |
| | | ~550 nm | | | particles & sprues. |
| EP157/30/3 | | Sputtered | water | ✓ | Slow and inefficient |
| Quadrant A | | AgAu | | | release, but nicely |
| | | ~1 μm | | | shaped intact |
| | | | | | particles. |

TABLE 10
Summary of release studies using Borax

| | | | | Shaped | |
|---|---|---|---|---|---|
| | Release Agent + | | Stripping | particles | |
| Sample ID | wetting treatment | Overcoat | medium | generated | Comments |
| EP157/30/6 | Borax + | Evaporated | water | ✓ | Efficient and |
| Octant B2 | corona | Al | | | quick release of |
| | | ~550 nm | | | shaped particles |
| | | | | | & sprues. |
| | | | | | FIG. 24a |
| EP157/30/6 | | Sputtered | water | ✓ | Efficient and |
| Quadrant C | | Permalloy | | | quick release of |
| | | ~1 μm | | | shaped particles |
| | | | | | & sprues; high |
| | | | | | proportion of |
| | | | | | broken particles. |
| | | | | | FIG. 24b |
| EP157/30/6 | | Sputtered | water | ✓ | Efficient and |
| Quadrant A | | AgAu | | | quick release of |
| | | ~1 μm | | | shaped particles |
| | | | | | & sprues. |

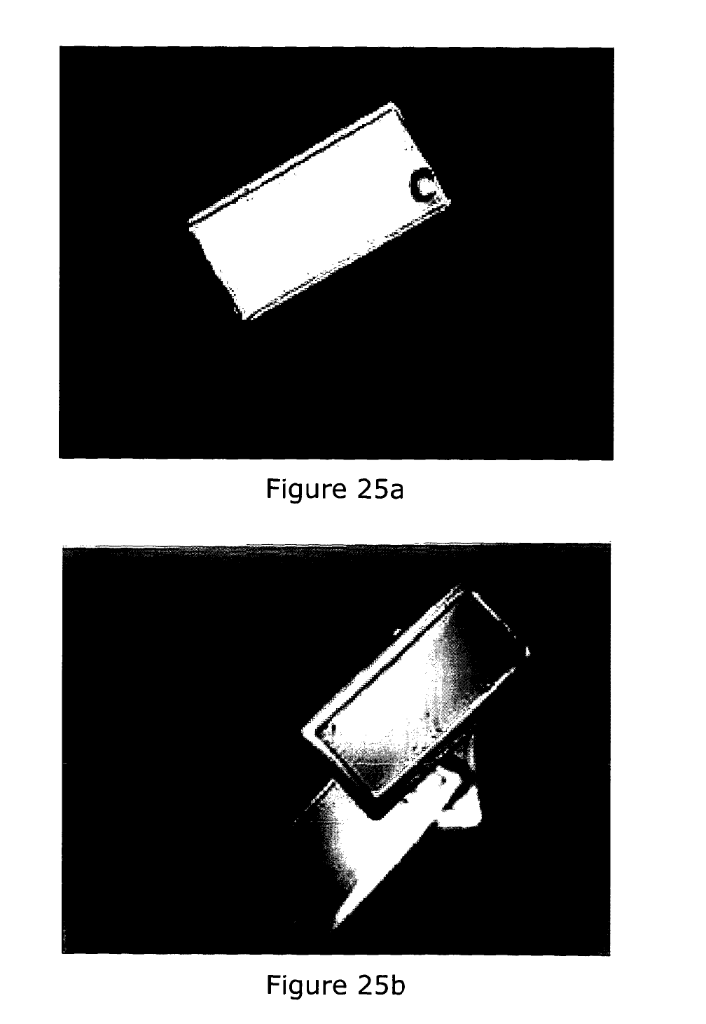

TABLE 11
Summary of release studies using Polyacrylamide

| | | | | Shaped | |
|---|---|---|---|---|---|
| | Release Agent + | | Stripping | particles | |
| Sample ID | wetting treatment | Overcoat | medium | generated | Comments |
| EP157/30/7 | Polyacrylamide + | Evaporated | water | ✓ | Reasonable release |
| Quadrant B | surfactant | Al | | | of shaped particles |
| | | ~240 nm | | | but tendency for |
| | | | | | breakage; released |
| | | | | | sprues intact & |
| | | | | | regular. |
| | | Evaporated | water | ✓ | Reasonable release |
| | | Al | | | of shaped particles |
| | | ~240 nm | | | but tendency for |
| | | | | | breakage; released |
| | | | | | sprues intact & |
| | | | | | regular. |
| | | Evaporated | water | ✓ | Reasonable release |
| | | Al (2 coats) | | | of shaped particles, |
| | | ~500 nm | | | reduced breakage c.f. |
| | | | | | 240 nm; released |
| | | | | | sprues intact & |
| | | | | | regular. |
| | | | | | FIG. 25a |
| EP157/30/7 | | Sputtered | water | ✓ | Reasonable release |
| Quadrant C | | Permalloy | | | of shaped particles |
| | | ~1 μm | | | and sprues. |
| | | | | | FIG. 25b |
| EP157/30/7 | | Sputtered | water | x | No significant release, |
| Quadrant A | | AgAu | | | probably due to heat |
| | | ~1 μm | | | damage during |
| | | | | | deposition. |
| EP157/30/8 | Polyacrylamide + | Evaporated | water | ✓ | Good efficient release |
| Quadrant B | corona | Al (1 coat) | | | of shaped particles |
| | | ~500 nm | | | and some sprue |
| | | | | | material. |
| EP157/30/8 | | Sputtered | water | ✓ | Slow to release but |
| Quadrant A | | AgAu | | | excellent release of |
| | | ~1 μm | | | intact, and very bright |
| | | | | | particles. |

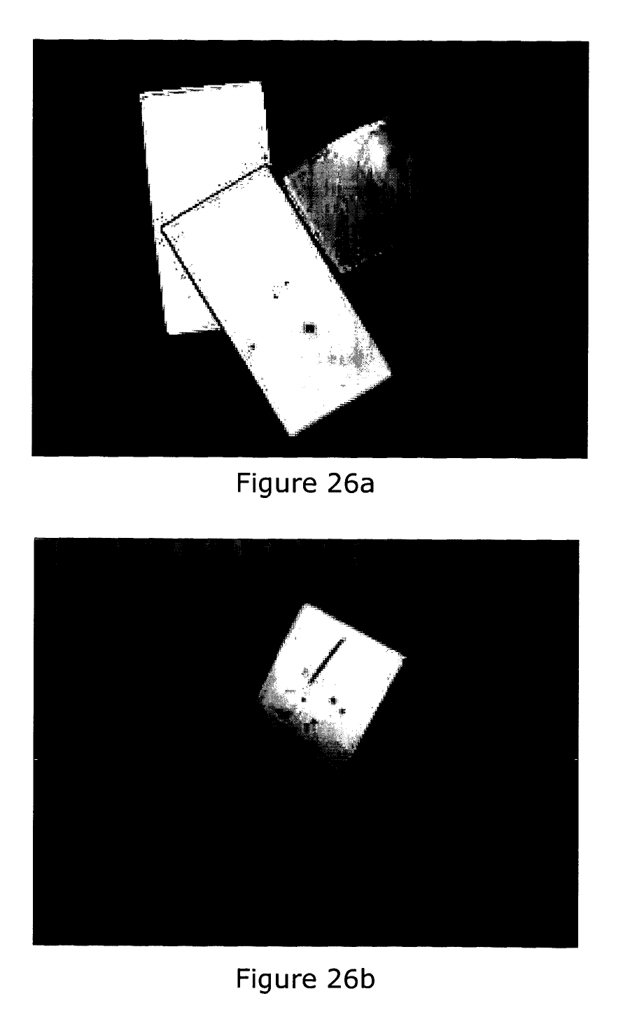

TABLE 12
Summary of release studies using PMMA

| | | | | Shaped | |
|---|---|---|---|---|---|
| | Release Agent + | | Stripping | particles | |
| Sample ID | wetting treatment | Overcoat | medium | generated | Comments |
| EP157/30/9 | LG156 PMMA | Evaporated | MEK | ✓ | Very quick and |
| Octant B2 | | Al (1 coat) | | | efficient release of |
| | | ~507 nm | | | shaped particles |
| | | | | | and sprues. |
| | | | | | FIG. 26a |
| EP157/30/9 | | Sputtered | MEK | ✓ | Very quick and |
| Quadrant C | | Permalloy | | | efficient release of |
| | | ~1 μm | | | shaped particles |
| | | | | | and sprues. High |
| | | | | | proportion of |
| | | | | | broken particles. |
| | | | | | FIG. 26b |
| EP157/30/9 | | Sputtered | MEK | ✓ | Very quick and |
| Quadrant A | | AgAu | | | efficient release of |
| | | ~1 μm | | | shaped particles |
| | | | | | with good flatness |
| | | | | | and surface |
| | | | | | morphology. |

Notes:
Sprues denote material release from the interstitial trenches.

The results were encouraging and showed that, even in this basic trial (where the stripping process had not been refined for any particular release agent system/flake material combination), the release agent systems selected were capable of providing flake particles of a selected size and shape.

This short study showed that a variety of water/organic solvent compatible materials may be used as release agents which enable the release of metallic flakes of controlled size and shape from an embossed substrate. These alternative materials are borax (sodium tetraborate, water soluble), polyacrylamide (water soluble) and PMMA (organic solvent soluble). The choice of most appropriate wetting treatment appears to depend on the particular release agent/embossed substrate system. Metallic flakes of both thermally evaporated aluminium (a pigment industry standard material/method) and sputtered alloys (magnetic and non-magnetic) were realised using the alternative release agent materials. In addition shaped particles of all 3 different flake materials were generated using the Laponite RD release agent with both the surfactant and corona discharge wetting treatments.

It will be appreciated that the embodiments described above illustrate the invention but are not to be regarded as restricting the invention. Other modifications or variations of the process or textured substrate will be apparent to the skilled person but will still be in accordance with the present invention. In particular, although the use of a clay mineral release layer or a PMMA release layer is highly preferred, other suitable release agents may also be used, particularly where, for example, the release is otherwise assisted, for example, by use of an adhesive transfer layer that removes the particles mechanically. Depending on the type of material being deposited as a thin film, a textured substrate with a coating of release agent or an inbuilt release layer, or indeed, a textured substrate with inherent releasability may be used.

Other particle shapes and sizes may also be selected in accordance with the present invention to those described above; particularly where the flakes are intended for applications other than pigments or paints.

1. A method of directly depositing discrete flake particles of a controlled size and shape comprising providing a textured substrate comprising an array of discrete, steep-sided exposed plateaus of a selected size and shape, and depositing a film forming material over the entire array such that it forms discrete, releasable flake particles of a corresponding size and shape on the plateaus.

2. A method of producing shaped flake particles comprising the steps of: —
a) providing a release system comprising a textured substrate comprising a plurality of discrete, steep-sided plateaus of a selected size and shape, and coated with a film of release agent;
b) producing a coated intermediate by depositing a film of material on the substrate such that it forms discrete flake particles on the plateaus;
c) releasing the discrete flake particles from the coated intermediate.

3. A method as claimed in claim 2, wherein the surface of the textured substrate is formed from an embossed photopolymer.

4. A method as claimed in claim 2, wherein the plateaus are delimited by steep side walls having a depth of at least 2 microns and optionally, a relief angle of between 0° and ±25°.

5. A method as claimed in claim 2, wherein at least half of the active area of the substrate comprises raised plateaus suitable for flake production, preferably with a minimum side dimension of at least 5 microns.

6. A method as claimed in claim 2, wherein the textured substrate has one of the following configurations: —
i) the active area of the substrate is formed predominantly of raised plateaus segregated by an interconnecting grid network of lower trenches;
ii) the active area of the substrate is formed predominantly of an alternating chequerboard of raised plateaus and sunken plateaus.

7. A method as claimed in claim 2, wherein the release agent is selected so as to cause release of the flake particles when the substrate is immersed in an aqueous medium, optionally with flexing and/or agitation.

8. A method as claimed in claim 7, wherein the release agent is a clay mineral.

9. A method as claimed in claim 2, wherein the material is a metallic or inorganic material and is preferably selected from a metal or a metal containing material.

10. A method of producing shaped flake particles as claimed in claim 2, wherein the substrate of step a) has been subjected to a wetting treatment, preferably a corona discharge treatment, to improve its subsequent wetting by the release agent.

11. A method of producing shaped flake particles as claimed in claim 2, wherein step a) includes applying a release agent solution that includes a wetting agent, preferably a surfactant, in order to improve wetting of the substrate by the release agent.

12. A method as claimed in claim 2 where the method is conducted using an elongate flexible web substrate in a reel to reel process.

13. (canceled)

14. A coated intermediate comprising a textured three-dimensional substrate having an array of discrete, steep-sided plateaus of a selected size and shape and coated with a discontinuous film of release agent, on top of which is deposited a discontinuous film of material in the form of releasable flake particles.

15. A coated intermediate as claimed in claim 14, wherein the steep sided plateaus are each coated with a discrete cap of release agent film on top of which cap is deposited a discrete flake of material of a related size and shape.

16. A release system for use in the method of claim 2 and comprising a textured substrate comprising a plurality of discrete, steep-sided plateaus of a selected size and shape, and coated with a discontinuous film of release agent that forms a discrete cap of release agent film on each plateau of a corresponding size and shape to that plateau.

17. A collection of flake particles, preferably in a liquid formulation that is water or organic solvent based, said particles being obtainable or obtained according to the method of claim 2, wherein most of the particles fall into one category of a particular size and shape, or several such distinct categories, the particles in any one category being substantially identical under microscopic examination.

18-19. (canceled)
